(19) United States
(12) Patent Application Publication
(10) Pub. No.: US 2026/0065673 A1
(43) Pub. Date: Mar. 5, 2026

(54) SYSTEMS AND METHODS FOR GENERATING TRAJECTORIES FROM BROADCAST FOOTAGE IMPLEMENTING DIFFUSION

(71) Applicant: STATS LLC, Chicago, IL (US)

(72) Inventors: Harry HUGHES, Brisbane (AU); Michael John HORTON, Wellington (NZ); Felix WEI, Melbourne (AU); Patrick Joseph LUCEY, Chicago, IL (US)

(73) Assignee: STATS LLC, Chicago, IL (US)

(21) Appl. No.: 19/309,109

(22) Filed: Aug. 25, 2025

Related U.S. Application Data
(60) Provisional application No. 63/688,049, filed on Aug. 28, 2024.

(51) Int. Cl. G06V 20/40; G06T 7/20

(52) U.S. Cl. CPC G06V 20/42; G06T 7/20; G06V 20/44; G06T 2207/30241

(57) ABSTRACT

Systems and methods for generating trajectories for one or more players during an event include receiving broadcast footage of a sporting event, determining tracking data of one or more players in the sporting event from the broadcast footage, the tracking data including one or more vectors, receiving event data of the sporting event, and inputting the one or more vectors and event data into a multimodal model including an event encoder and a tracking decoder. A linear layer of the multimodal model may be applied to the vectors and event data to tokenize the event data and vectors. A tensor representing a sequence of the event data and tracking data may be determined. Perturbed tracking data of the sporting event and the tensor may be input into a diffusion model. The diffusion model may generate one or more trajectories for the one or more players in the sporting event.

### CROSS-REFERENCE TO RELATED APPLICATIONS

This application claims the benefit of U.S. Provisional Patent Application 63/688,049 filed Aug. 28, 2024, the entire contents of which are incorporated herein by reference for all purposes. Further, application incorporates by reference the entire content of U.S. Non-Provisional patent application Ser. No. 18/401,006 filed Dec. 29, 2023.

### TECHNICAL FIELD

Various aspects of the present disclosure relate generally to machine learning for sports applications; in particular various aspects relate to systems and methods for reconstructing multi-agent soccer trajectories using long-term multimodal contexts. Various aspects further relate to generating trajectories from broadcast footage by using diffusion techniques.

### INTRODUCTION

Conventional systems that model the behaviors of agents in a sport (e.g., soccer) may be limited in at least two respects: (i) they may only focus on short-term context windows (≤10 seconds) which may not be suitable for reconstructing noise that persist for long periods of time, and (ii) they may exclusively rely on trajectory context, and may not be configured to leverage auxiliary data streams that can provide additional context.

Unless otherwise indicated herein, the techniques and information described in this section are not prior art to the claims in this application and are not admitted to be prior art, or suggestions of the prior art, by inclusion in this section.

### SUMMARY

In some aspects, the techniques described herein relate to generating trajectories for one or more players during a sporting event, including receiving, as an input, broadcast footage of a sporting event; determining tracking data of one or more players in the sporting event from the broadcast footage, the tracking data including one or more vectors; receiving event data of the sporting event; inputting the one or more vectors and event data into a multimodal model, the multimodal model including: an event encoder; and an tracking decoder; applying a linear layer of the multimodal model to the one or more vectors and event data to tokenize the event data and one or more vectors; determining, by the multimodal model, a tensor, the tensor representing a representation of sequence of the event data and tracking data; receiving perturbed tracking data of the sporting event; inputting the perturbed tracking data and tensor into a diffusion model, wherein the diffusion model includes a decoder; and generating, by the diffusion model, one or more trajectories for the one or more players in the sporting event.

One or more vectors includes at least one of an agent's two dimensional coordinates on a sporting event's field, an agent position, an agent team, an indicator indicating the agent is a ball, or player visibility information. The event data may be derived from the broadcast footage. The event data may include a sequential stream of one or more major events throughout a sport event, the major events including at least one of a pass, shot, tackle, foul, turnover, penalty, goal, score, or substitution from the sporting event. The event encoder may not include a temporal attention layer wherein the event encoder is a non-temporal encoder that processes input events without modeling temporal dependencies through attention mechanisms.

Determining, by the multimodal model, a tensor further includes: adding a first set of sinusoidal positioning embeddings to the event data; and processing the event data by applying a transformer encoder in the event encoder to produce event embeddings. Determining, by the multimodal model, a tensor further includes: adding a second set of sinusoidal positioning embeddings to tokenized versions of the one or more vectors; encoding the tokenized version of the one or more vectors by an attention based module in the tracking decoder; applying cross attention of the event embeddings to the encoded tokenized versions of the one or more vectors; applying a normalization layer to the encoded tokenized versions of the one or more vectors; and applying a feedforward layer to the encoded tokenized versions of the one or more vectors.

The generating, by the diffusion model, one or more trajectories for the one or more players in the sporting event further includes: applying a linear layer to the perturbed tracking data; applying sinusoidal positional encoding to the perturbed tracking data; applying, by the diffusion model, spatiotemporal axial attention to the perturbed tracking data; and applying cross-attention to the perturbed tracking data with the tensor.

The one or more trajectories may include a predicted sequence of movements for the one or more players for a next approximately sixty seconds of the sporting event.

The techniques may further include generating future trajectories of the one or more players by analyzing the one or more trajectories.

Techniques disclosed herein may be performed by a system for generating trajectories for one or more players during a sporting event, the system comprising: a memory configured to store processor-readable instructions; and a processor operatively connected to the memory, and configured to execute the instructions to perform operations including those discussed herein (e.g., above).

Techniques disclosed herein may be performed by a non-transitory computer readable medium configured to store processor-readable instructions, wherein when executed by a processor, the instructions perform operations including those discussed herein (e.g., above).

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to one or more embodiments.

FIG. 2 is a graph of trajectory reconstructions, according to one or more embodiments.

FIG. 3 is a graph visualization of forward and reverse diffusion processes, according to one or more embodiments.

FIG. 4 is a diagram of exemplary data inputs of the system described in FIG. 5, according to one or more embodiments.

FIG. 5 is a block diagram of a prediction system for generating trajectories, according to one or more embodiments.

FIG. 6 is a set of graphs depicting visualization of broadcast tracking reconstruction settings, according to one or more embodiments.

FIG. 7 depicts a set of graphs visualizing the frequency of pass failure of a set of models, according to one or more embodiments.

FIG. 8A-8C depict approaches to trajectories, according to one or more embodiments.

FIG. 9 depicts a graph of spatiotemporal axial attention, according to one or more embodiments.

FIG. 10 depicts a block diagram of a multimodal system, according to one or more embodiments.

FIG. 11 depicts graphs of performance over longer time segments, according to one or more embodiments.

FIG. 12 depicts graphs of performance over a full game, according to one or more embodiments.

FIG. 13A-13B depict exemplary reconstructions of tracking data, according to one or more embodiments.

FIG. 14A-14C depict exemplary forms of occlusion that occur during a broadcast, according to one or more embodiments.

FIG. 15 depicts a graph displaying detection of players per frame, according to one or more embodiments.

FIG. 16 depicts a graph displaying the frequency of different levels of tracking errors, according to one or more embodiments.

FIG. 17 depicts a flowchart of an exemplary method of generating a trajectory according to one or more embodiments.

FIG. 18 depicts a flow diagram for training a machine-learning model, according to one or more embodiments.

FIG. 19A is a block diagram illustrating a computing device, according to one or more embodiments.

FIG. 19B is a block diagram illustrating a computing device, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure relate generally to machine learning for sports applications; in particular various aspects relate to systems and methods for reconstructing multi-agent soccer trajectories using long-term multimodal contexts. Various aspects further relate to generating trajectories from broadcast footage by using diffusion techniques.

The systems and methods described herein my incorporate a multi-modal model combined with a diffusion model to generate trajectories based on broadcast footage. The multi-modal agent may reconstruct noisy trajectories of soccer agents. It may fuse soccer tracking data with event data, providing strong connections that cannot be strictly inferred from raw trajectories. The system may be configured to generate multi-agent trajectories for each player and a ball in a sporting event such as soccer.

Broadcast tracking (e.g., extracting player and ball locations from broadcast footage) may be used to generate tracking data across televised games of sporting events such as professional soccer. Although computer vision systems can track agents while they are visible in the broadcast, they may be inherently unable to track agents when they are out-of-view. Recent approaches have therefore focused on reconstructing incomplete agent trajectories. These methods exhibit strong performance in terms of predicting agents to be in the correct coarse locations, however they often predict collective behaviors that are not photorealistic. This may especially affect the realism of passes. The system described herein may address this limitation, among others, by incorporating a diffusion-based generative model for reconstructing multi-agent trajectories. By generating trajectories via iteratively denoising a random sample, diffusion models may be able to hone the fine-grained details of trajectory sets over time. This may increase the photorealism of generated behaviors around passes. The generative architecture may build on top of a multimodal foundation model (e.g., a multimodal foundation soccer model), which may provide strong conditioning information as to agents' coarse locations. The techniques described herein may be validated empirically, showing that 98% of passes the model predicts appear photorealistic in an exemplary scenario, versus 82% obtained by previous methods.

Soccer may be a valuable testbed for studying multi-agent adversarial systems. The systems and methods described herein focus on reconstructing noisy trajectories of soccer agents (players and the ball). Conventional systems that model the behaviors of agents in soccer may be limited in at least two respects: (i) they may only focus on short-term context windows ($10 seconds) which may not be suitable for reconstructing noise that persist for long periods of time, and (ii) they may exclusively rely on trajectory context, and may not leverage soccer's auxiliary data streams that can provide additional context. The systems and methods described herein may address these limitations. Although the systems and methods are described in reference to soccer, it will be understood that these systems and methods are not limited to soccer. Rather, these systems and methods including the embodiments disclosed herein may be applicable to any team or individual sport. First, the architecture may model soccer's long-term structure by processing long-term trajectories (e.g., for a duration such as sixty seconds). Secondly, the architecture may be multimodal. Specifically, it may fuse soccer tracking data with event data (which specifies the high-level semantic events that transpire in a game), providing rich context that cannot strictly be inferred from the raw trajectories. The method may be validated empirically using a reconstruction loss metric. Compared to conventional approaches, the method described herein substantially improves the accuracy of an object (e.g., the ball's) and players reconstructed trajectories.

Examining modeling multi-agent trajectories, multi-agent trajectory sets may have two dimensions: a temporal dimension, which distinguishes between each timestep, and a spatial dimension, which distinguishes between each agent. These dimensions may correspond to the two challenges of multi-agent trajectories; agent motion must be temporally coherent, whilst also observing inter-agent spatial dynamics. Some approaches used handcrafted heuristic and energy-based approaches for modeling these spatiotemporal dynamics. However, the non-linear nature of multi-agent scenes have meant that deep learning methods may have increasingly been applied to these problems. Recurrent Neural Networks (“RNN”) may commonly be used to model each agent's temporal context, with pooling or Graph Neural Networks (“GNNs”) may be used to distribute this context spatially amongst agents. With the success of Transformers in sequential learning tasks attention-based architectures may now be used to jointly model these spatiotemporal dynamics. Due to the quadratic blowup of self-attention with respect to sequence length, coupled with the high dimensionality of multi-agent trajectory sets, some approaches aim to increase the efficiency of the self-attention mechanism. The system described herein may be inspired by axial attention and use spatiotemporal axial attention to apply self-attention separately across the temporal and spatial axes of trajectory sets. This operation has strong spatiotemporal inductive biases which may be more computationally efficient than fully attending across trajectories.

Examining multi-agent trajectory reconstruction, within multi-agent trajectory modeling, various approaches may be considered for the task of imputation. For example, multiresolution RNNs may be applied to recursively reconstruct partial trajectories. This approach may model agents independently and therefore may not encode the spatial dependencies that exist in multi-agent scenes. While some approaches model these spatial correlations, they may only leverage past temporal context. In contrast, implementing a graph imputer may include focusing on reconstructing broadcast tracking (e.g., for soccer) using bidirectional temporal context. This may be done by fusing predictions made forwards and backwards in time. Each directional prediction may follow and use an RNN to model each agent's context and a GNN to distribute this inter-agent context. This approach may be limited by its tracking-only input and its focus on short term trajectories (<10 seconds in duration). These limitations restrict its capacity to reconstruct longer term occlusions. A multimodal model may address these challenges by using long-term multimodal input (e.g., event data and broadcast tracking data) with a Transformer-based approach. However, this approach may be limited in terms of its coarse L2 reconstruction loss function, that often results in fine-grained behaviors that are not realistic.

Examining multi-agent trajectory generation, this may include trajectory generation which may be the task of estimating the probability distribution of a trajectory set. This distribution can either be unconditional or be conditioned on prior context. Some approaches use Generative Adversarial Networks (“GANs”) to draw samples from an implied distribution while other approaches use Conditional Variational Autoencoders (“CVAEs”) to sample from a latent distribution. In other domains, denoising diffusion probabilistic models (e.g., diffusion models) are a powerful approach for directly modeling complex multimodal data distributions, exhibiting remarkable success in generative tasks and audio. These models may be applied to the generation of single-agent and multi-agent trajectories.

Methods for modelling multi-agent trajectories may focus on two environments which consist of multiple humans interacting in a continuous spatiotemporal environment: pedestrian scenes and sporting scenes.

Pedestrian trajectory prediction may use heuristic and energy-based methods to model agents' spatiotemporal relationships. Deep learning methods may be well-suited to extracting the non-linear multi-agent dynamics from tracking data. Recurrent neural networks (RNNs) may be used to model each agent's temporal history. This temporal context may typically be distributed spatially via pooling or with graph neural networks (GNNs). Transformers may be used in sequential learning tasks and attention-based architectures may be used to jointly encode both the spatial and temporal dimensions of multi-agent trajectories. However, transformers may have quadratic complexity with respect to sequence length, which may be limiting when applied to high-dimensional multi-agent trajectory sets. As a result, embodiments disclosed herein may increase the efficiency of transformers when applied to tracking data. One notable approach may be spatiotemporal axial attention which applies self-attention separately across the temporal and spatial axes of multi-agent trajectory sets.

These approaches typically focus on short-term trajectories (≤10 seconds in duration). This may be because (i) these trajectories are gathered using cameras with relatively narrow fields-of-view, and (ii) off-screen behaviors may be assumed to not be relevant to scenes. Despite this, spatiotemporal axial attention may have suitable properties for modelling longer trajectories than previously studied.

Modeling systems may use multi-agent trajectories in sporting scenes, including trajectory forecasting over short-term horizons (≤10 seconds). Multi-agent trajectory imputation may also be used in sporting scenes. For example, a system may use bidirectional context to impute missing basketball trajectories. However, this approach models each agent independently and does not model the spatial correlations that exist in multi-agent scenes. System(s) that model these spatial correlations may only leverage past temporal context. A system may focus on reconstructing soccer broadcast tracking data using bidirectional temporal context. This approach may model bidirectional context by making two independent predictions, one operating forwards in time (only using past context) and one operating backwards in time (only using future context). These directional predictions may be fused via averaging. Separately modelling future and past context is more limited for longer trajectories, where forwards and backwards predictions tend to be less closely correlated. However, this system may focus on short-term trajectories (e.g., 9.6 seconds) where the first and final seconds are visible.

Systems and methods described herein investigate a realistic setting for the reconstruction of broadcast tracking. Specifically, the systems and methods use real broadcast tracking data and makes no assumptions about the visibility of agents (e.g., at the starts or ends of trajectories). This may considerably increase both the duration of agent occlusions, and as a result, the difficulty of the trajectory reconstruction task.

In many environments, the behaviors of agents may strongly depend on scene-level context. Alternative systems may statically map elements from top-down images of scenes using convolutional feature extractors. These approaches may be limited by (i) the high dimensionality of convolutional feature maps which make modelling longer sequences difficult, and (ii) the need for complex handcrafted fusion of image features with multi-agent trajectories. Transformers may have broad utility in fusing diverse data modalities such as text, video, and audio. Alternative systems may further use attention-based architectures to encode and fuse multi-agent trajectories with other spatiotemporal modalities relevant in an autonomous driving setting. Other alternative systems may exclusively use a sporting event's event stream to infer the locations of agents at each event (using no trajectory context).

The system described herein may fuse event data (as further described herein) and multi-agent trajectories using a transformer-based representation.

Advantageously, the system may incorporate both event data and broadcast tracking data to generate trajectories. The system may implement a diffusion model to fine-grain details of trajectory sets over time, while building on a multimodal foundation model. In particular, the diffusion model may substantially improve the realism of multiagent behavior around passing events during a soccer game.

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value. In this disclosure, unless stated otherwise, any numeric value may include a possible variation of ±10% in the stated value.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

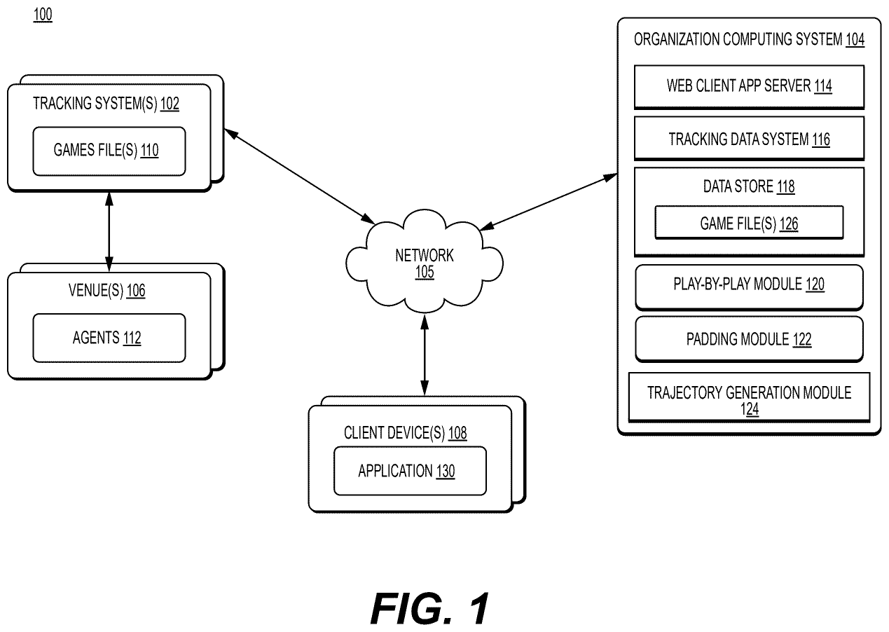

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connections to be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationery and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet-based channels, etc.). A game file 110 may be converted from a first format (e.g., a format output by the one or more cameras or a different format than the format output by the one or more cameras) and may be converted into a second format (e.g., for broadcast transmission).

As an example, tracking data may include the positions (e.g., x=(x, y)) of each entity (or player) at each time step on a playing surface. In some embodiments, to represent the tracking data in a well-defined structure that avoids issues presented in conventional approaches, a pre-processing agent may construct a graphical representation (e.g., digital representation) of the tracking data. The graphical representation may be in a different format than broadcast data and may be generated by extracting object information from the broadcast data to generate the graphically represented tracking data in a tracking data format. For example, a pre-processing agent may construct a graph G (V,E,U) that may be defined by nodes V, edges E, and global features U. In some embodiments, each node in a graph may represent the player and ball tracking data. In some embodiments, each edge may include information about various relationships between nodes. In some embodiments, edges eij may be directed edges and connect a sending node vi to a receiving node vj.

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession-based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events. In some examples, the broadcast footage (e.g., derived from game files 110) may be analyzed by applying these techniques to generate a sequential stream of one or more major events throughout a sport event, the major events including, for example, at least one of a pass, shot, tackle, foul, turnover, penalty, goal, score, or substitution from the sporting event.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or trajectory generation module 124. Each of tracking data system 116, play-by-play module 120, padding module 122, and trajectory generation module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code, the processor of organization computing system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. The tracking data may be, for example, a digital representation of individuals, objects, and/or aspects of a sporting event, as further discussed herein. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such a process, organization computing system 104 may go beyond the generation of tracking data from broadcast video data. Instead, to provide descriptive analytics, as well as a useful feature representation for trajectory generation module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

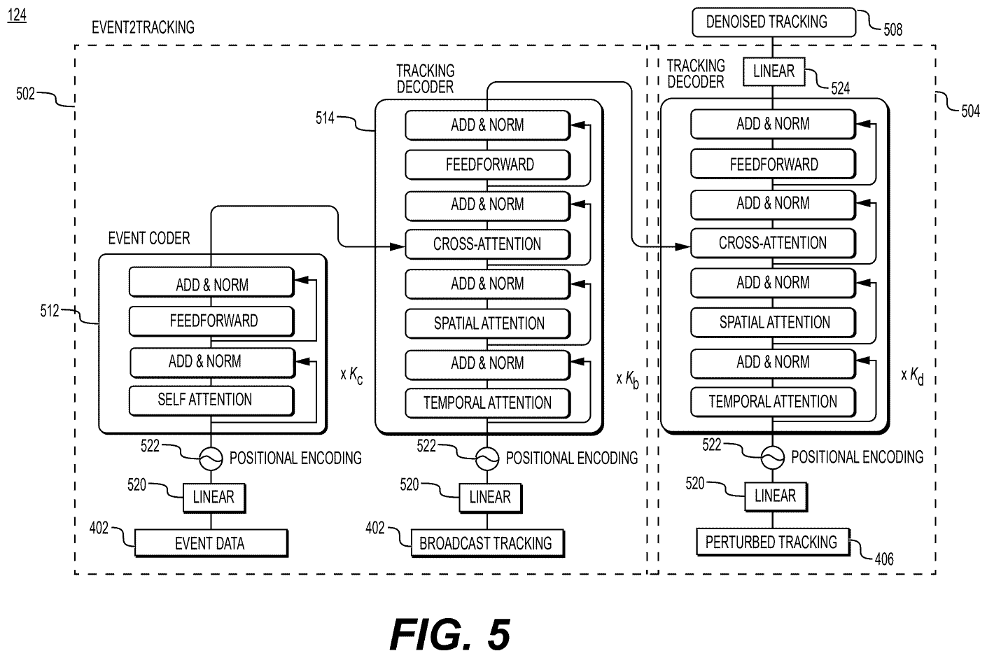

The trajectory generation module 124 may be configured to generate one or more trajectories for a sporting event based on broadcast footage. The trajectory generation module 124 may incorporate a multimodal model and a diffusion model as described in greater detail below, such as in conjunction with FIG. 5. The trajectory generation module 124 may incorporate one or more machine learning models.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competitive landscape. A sports machine learning model may be trained to adjust one or more weights, layers, nodes, biases, and/or synapses to associate certain sports statistics in view of a competitive landscape. For example, a win indicator for a given team may automatically correlate with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and changes. For example, a sports machine learning model may be trained by modifying one or more weights, layers, nodes, biases, and/or synapses to associate given positions in reference to the playing surface of venue and/or in reference to none or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with locations of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer-based sports machine learning model may be trained to correlate or otherwise associate player position information with reference to a soccer pitch. The soccer-based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as generative learning, linear regression, logistic regression, random forest, gradient boosted machine (GBM), deep learning, graphical neural network (GNN), and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine learning, it should be understood that techniques according to this disclosure may be adapted to any suitable type of machine learning. It should also be understood that the examples above are illustrative only. The techniques and technologies of this disclosure may be adapted to any suitable activity.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104. For example, client device 108 may be configured to execute application 130 to access generated trajectories. The content that is displayed to client device 108 may be transmitted from web client application server 114 to client device 108 and subsequently processed by application 130 for display through a graphical user interface (GUI) of client device 108.

Tracking data may be used for fine grained measurement of player performance in sporting events such as soccer. The received data source may contain the (x, y) centers of mass of all agents (players and the ball) at a high framerate (˜25 Hz). In some examples, this tracking data may be extracted from raw pixels captured by video, and may provide a low-dimensional, tractable, and interpretable representation of player behaviors in games. It may be used directly for visualization or fitness measures, or as the input for subsequent models for downstream tactical analyses.

Traditionally, tracking data has been extracted using in-venue systems, which use multiple on-location cameras to track agents. The high installation and management costs of these systems have meant that they may be only available in a handful of leagues. Embodiments disclosed herein use broadcast tracking, where agents are tracked directly from broadcast footage. An advantage of these systems may include that they may scale across all televised or streamed games. With this immense value proposition in mind, the optimization of these systems may be valuable. In some examples, the optimization comes from the perspective of computer vision. However, computer vision approaches are inherently unable to track agents when they are not visible in broadcast footage. These occlusions may lead to large portions of the game that are missing, which in turn restricts the utility that raw broadcast tracking can provide for downstream analysis.

A growing research area may focus on reconstructing broadcast tracking. This task involves jointly inputting missing agent locations and denoising erroneous trajectories. There may be two key objectives related to the task of generating multi-agent trajectory sets. The first of these objectives is for reconstructed trajectory sets to have coarse realism. Given that soccer is a spatially structured game this means that agents may be roughly in the correct locations on the pitch. Secondly, trajectory sets may also exhibit fine-grained realism, meaning that the details of collective behaviors must be photorealistic.

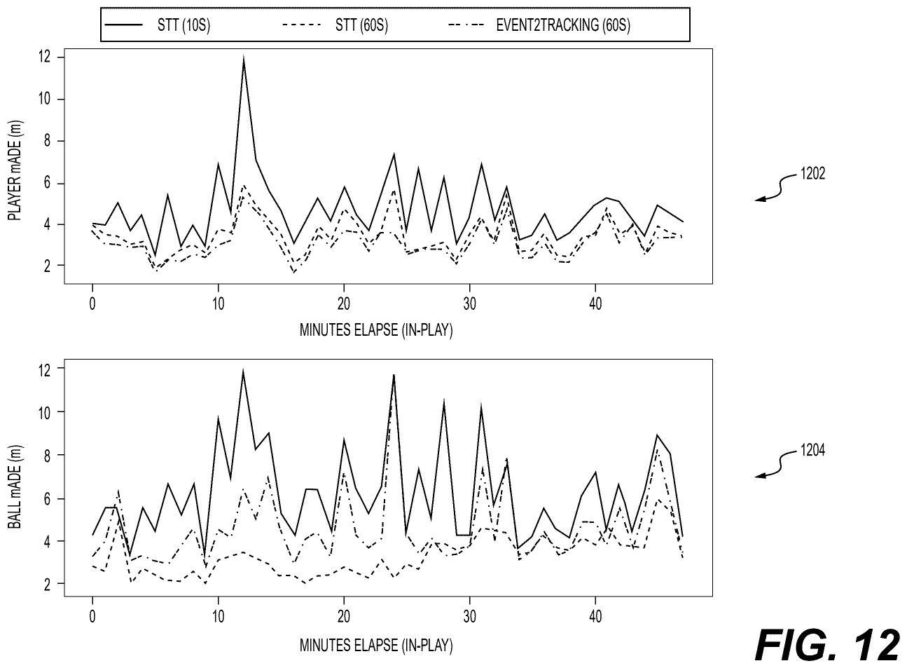

A state-of-the-art novel approach for trajectory re-construction in this setting is the Event2Tracking model (e.g., the multimodal model 502 described in FIG. 5 and FIG. 12). As used herein, “Event2Tracking” may generally correspond to a multimodal model such as the multimodal model 502, which is further discussed herein. This architecture may be trained deterministically to minimize £2 reconstruction loss between predicted and ground-truth trajectories. It may do this by leveraging long-term multimodal context, using broadcast tracking as well as event data. Event data may specify semantic details of the key actions players complete with the ball (e.g., passes, tackles, interceptions) and therefore represents a useful auxiliary data source for reconstructing parts of the game where broadcast tracking is more limited.

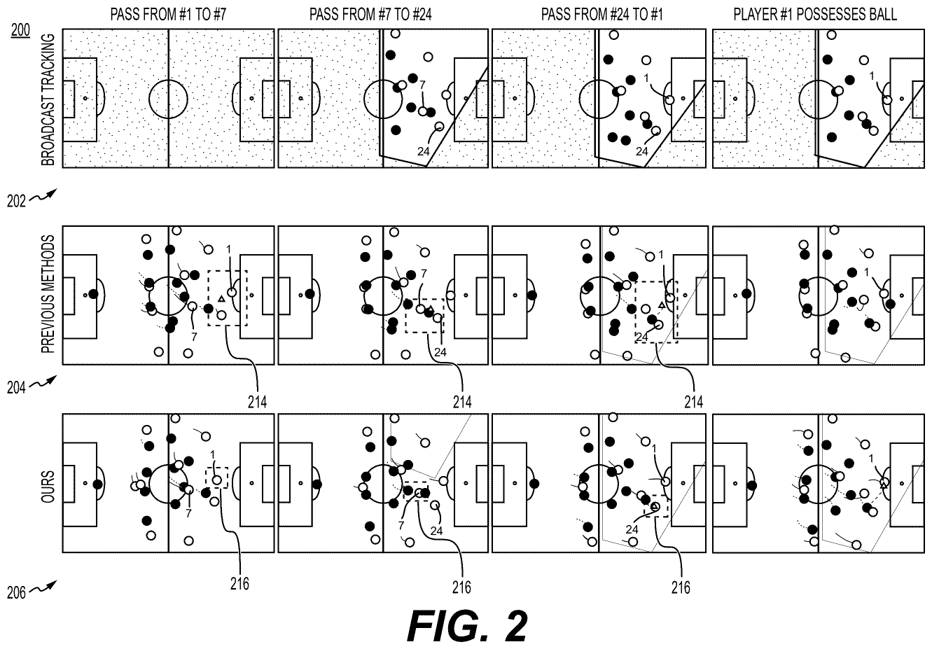

Although this architecture exhibits strong performance in terms of coarse realism (e.g., predicting agent locations), it may be limited in terms of fine-grained realism. This limitation presents itself in terms of reconstructing pass events. Passes are actions where ownership of the ball is intentionally transferred between two players on the same team. At the most basic level, the moment that the pass occurs the ball and player must be in close proximity to each other. The Event2Tracking model often does not achieve this, as is shown in FIG. 2. To understand the results, it may be first observed that each agent is roughly in the correct locations in the examples of FIG. 2. As a result, these situations may not necessarily be prioritized by the model because they do not incur high L₂ reconstruction losses. These small discrepancies may however cause major degradations in terms of the photorealism of reconstructed trajectories and therefore diminish the ability for this data to be used for downstream analysis.

FIG. 2 is a graph 200 of trajectory reconstructions, according to one or more embodiments. FIG. 2 displays the trajectory reconstruction setting, where the locations of missing agents are predicted. Broadcast tracking 202 may be extracted from broadcast footage via computer vision. While coarse approaches 204 predict coarsely accurate locations for each agent, these methods often fail to reconstruct accurate fine-grained behaviors. This particularly affects passes, where the ball is frequently disjointed from the player making the pass as shown by boxes 214. As shown across the Y-axis, a first set of sub-graphs show a pass from player #1 to player #7, a second set of sub-graphs show a pass from player #7 to player #24, a third set of sub-graphs show a pass from player #24 to player #1, and a fourth set of sub-graphs show payer #1 possessing the ball. For each such event, broadcast tracking data, previous method data, and the data 206 representing the methods and systems disclosed herein (labeled “Ours”) are each shown across the X-axis. The methods and systems described herein addresses the issue of failing to reconstruct accurate fine-grained behaviors in predicting passes with substantially greater fine-grained realism as shown by boxes 216.

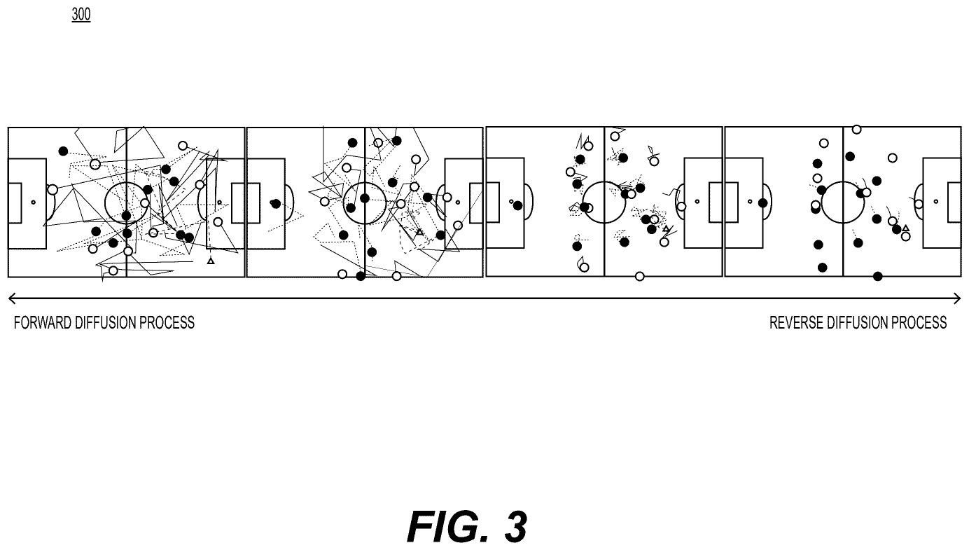

The coarse and fine-grained realism can be jointly optimized via denoising diffusion probabilistic models (e.g., diffusion models) as described herein. Diffusion models may be used to generate a wide variety of data modes, such as images, audio, and trajectories. By generating data via iteratively denoising samples from pure noise, as depicted in FIG. 3, diffusion models may be conceptually well-suited to this task, because they can hone the fine-grained realism of collective behaviors over time.

FIG. 3 is a graph 300 visualization of forward and reverse diffusion processes, according to one or more embodiments. The graph 300 visualizes the forward and reverse diffusion processes. The forward diffusion process gradually perturbs ground-truth trajectories with scaled Gaussian noise, up to the point where the sample is indistinguishable from pure Gaussian noise. Diffusion models, such as the one described herein, may be trained to predict the underlying sample from noise, effectively reversing this process.

The diffusion model described herein (e.g., diffusion model 504 of FIG. 5) may reconstruct multi-agent trajectory sets. This approach may substantially improve the realism of multi-agent behaviors around pass events. This diffusion model may be built on top of the Event2Tracking architecture (e.g., multimodal model 502), which enables the generative approach to condition on long-term multimodal context (e.g., event data and broadcast tracking data). This may allow for improvements in terms of fine-grained realism not to come at the cost of trajectory sets' coarse realism. Advantageously, the trajectory generation module 124 may incorporate some of the following techniques.

The diffusion models may be applied to the multi-agent trajectory reconstruction setting, showing how this generative approach substantially increases the fine-grained realism of predicted trajectories. The system may maintain coarse realism by conditioning on long-term multimodal context. This multimodal context may contain event data as well as broadcast tracking data. For example, experimental results show that 98% of passes the trajectory generation module 124 predicts are photo realistic, compared with only 82% from previous approaches. This improvement comes while maintaining the strong coarse realism of previous approaches.

The objective of this system may be to infer a probability density function p(x; c) of a trajectory set x depending on context c. The trajectory set x has shape [T, E, 2], specifying the (x, y) locations of the E agents over the T timesteps in the trajectory. Typically, E=23, where there are two teams of 11 players and one ball. However, this value can decrease (e.g., due to an injury or a red card). Models may be robust to this variable number of agents in each scene. Context c may be provided by broadcast tracking data y and event data z. Broadcast tracking has an identical shape to x, except each observation has of d_{y} features. This includes the agent's (x, y) coordinate, the agent's role and team affiliation, and their team's current formation. When agents are occluded, their locations are set to a constant value outside the pitch's coordinates. Event data on the other hand has shape [L, d_{z}], where L is the number of events in the trajectory window and d_{z} is the number of features in each event. Events include the (x, y) coordinate, one-shot encodings of the event category (e.g., pass, interception, tackle), and the agent who completed the event's identifying information.

Denoising diffusion models may be implemented by the trajectory generation module 124 described herein. Such diffusion models may consider the family of distributions p(x, σ) where Gaussian noise of standard deviation σ is added to a data distribution p_{data}(x) with standard deviation σ_{data}. Where the Gaussian noise standard deviation may be maximized (e.g., σₘₐₓ), this perturbed data distribution may be virtually indistinguishable from pure Gaussian noise. Samples from this data distribution may thus be generated by iteratively denoising x₀˜N(0, σ²max|) over range σₘₐₓ, . . . , σ_{N-2}, σ_{N-1} such that xᵢ˜p(xᵢ, σᵢ). Score-based diffusion models may frame this reverse diffusion process as an ordinary differential equation (ODE) where the derivative of the noised sample x is given by:

$$dx = - \dot{σ} ( t ) σ ( t ) {∇}_{x} log p ( x , σ ) , \qquad ( 1 )$$

Where ∇ₓ log p(x, σ) gives the score function, σ(t) is the noise level at diffusion step t, and \dot{σ}(t) is the time derivative of σ. The score function may be a vector field that gives the direction where the probability density function grows most quickly, from which the underlying probability density function can be inferred. The probability distribution's score function can be obtained by training a conditional de-noising model D_{θ}(x, σ, c) parameterized by θ to minimize the L₂ reconstruction loss between the perturbed and original data sample,

$${E}_{σ ∼ q ( σ )} {E}_{x , c \cdot {ρ}_{data}} {E}_{n ∼ N ( 0 , {σ}^{2} I )} // {D}_{θ} ( \overline{x} ; σ , c ) - x // \frac{2}{2} \qquad ( 2 )$$

Where q denotes the distribution of σ during training and y=x+n. Following this definition, the score is given by:

$${∇}_{y} log p ( \overline{x} , σ , c ) = ( {D}_{θ} ( \overline{x} ; σ , c ) - x ) / {σ}^{2} \qquad ( 3 )$$

Rather than returning the direct output of the denoiser network, preconditioning terms are added to both scale the variance of the model's inputs, and a skip connection to enable the model to adaptively predict either the noise level or the clean signal at different levels of σ. The denoiser can be written as,

$${D}_{θ} ( \overline{x} ; σ , c ) = {c}_{skip} ( σ ) \overline{x} + {c}_{out} ( σ ) {F}_{θ} ( {c}_{input} ( σ ) \overline{x} ; {c}_{noise} ( σ ) , c ) \qquad ( 4 )$$

Such that F_{θ} is the raw neural network's output, cᵢₙₚᵤₜ modulates the perturbed trajectory's variance, cₙₒᵢₛₑ modulates the noise's variance, cₒᵤₜ modulates the output's variance, and cₛₖᵢₚ modulates the skip connection. To normalize losses over the σ range, the per-sample reconstruction losses are scaled by term

$$λ ( σ ) = 1 / {c}_{out}^{2}$$

For sampling, models may use a maximum noise level such as σₘₐₓ=80. In an example, all predictions were sampled iteratively using 12 diffusion steps.

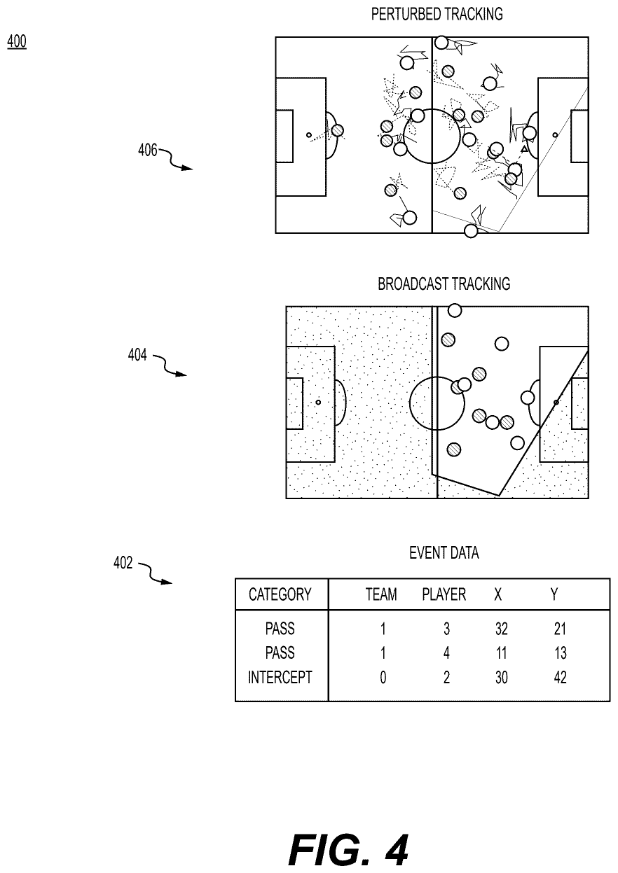

FIG. 4 is a diagram 400 of exemplary data inputs of the system described in FIG. 5, according to one or more embodiments. The diagram 400 of FIG. 4 visualizes inputs to the model, including perturbed tracking data 406 (which contains the ground-truth trajectories perturbed with scaled Gaussian noise), broadcast tracking data 404, and event data 402. For example, the diffusion model discussed herein (e.g., diffusion model 504 of FIG. 5) may be trained by perturbing ground-truth tracking data by gaussian noise (e.g., via one or more levels of gaussian noise which is injected into trajectories determined using the ground-truth tracking data). Given the output for the Event2Tracking model (e.g., multimodal model 502) may closely resemble the ground-truth tracking data (or some type of perturbation around it), this training using the perturbing may be sufficient for training the diffusion model. Alternatively, or in addition, a conditional model may be generated (e.g., trained) that maps the observed noisy trajectory from the Event2Tracking model to the clean model or data. Alternatively, or in addition, the diffusion may be performed without the Event2Tracking according to some embodiments.

In some examples, the event data 402 may include a sequential stream of one or more major events throughout a sport event, the major events including at least one of a pass, shot, tackle, foul, turnover, penalty, goal, score, or substitution from the sporting event. In some examples, the event data 402 may automatically be derived from the broadcast data (e.g., as discussed in FIG. 1). The broadcast tracking data 404 may include one or more vectors derived from broadcast footage. The one or more vectors may include at least one of an agent two dimensional coordinates on a sporting event's field, an agent position, an agent team, an indicator indicating the agent is a ball, or player visibility information.

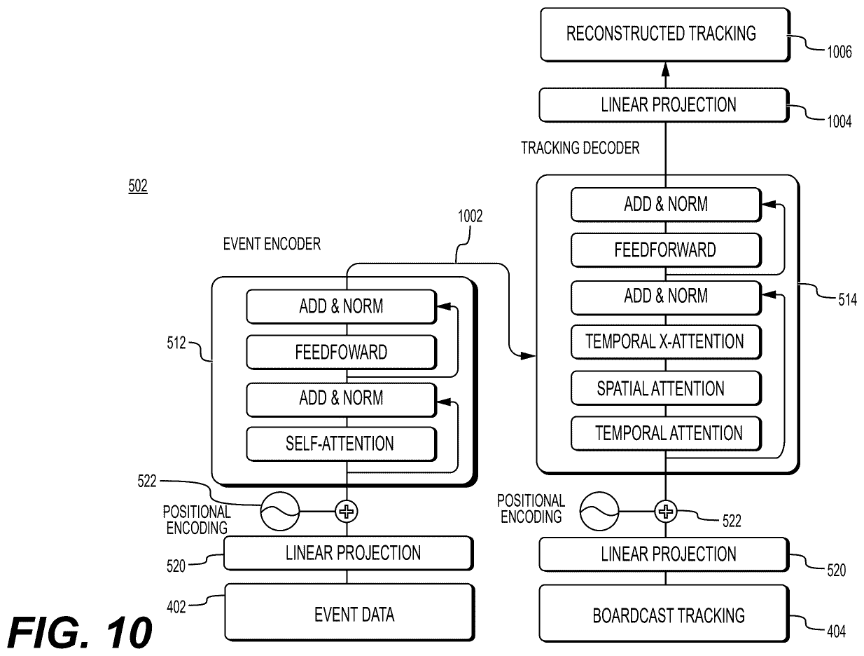

FIG. 5 is a block diagram of a prediction system for generating trajectories, according to one or more embodiments. The prediction system may for example be the trajectory generation module 124 described in FIG. 1. FIG. 5 may display the trajectory generation module 124 architecture which may include a multimodal model 502 (e.g., Event2Tracking model described herein) and a diffusion model 504. The diffusion model 504 may be a generative model, which is trained to denoise the artificially perturbed tracking stream. The diffusion model 504 may also be conditioned on event data and broadcast tracking context via cross-attending to the outputs of the multimodal model 502. The multimodal model 502 may include an event encoder 512 and a tracking decoder 514, as may be described in greater detail in FIG. 10 below. The diffusion model 504 may receive perturbed tracking data 406 as well as a tensor output by the multimodal model 502, which will be described in greater detail below. The diffusion model 504 may output one or more trajectories for the one or more players in a sporting event. The one or more trajectories may include denoised tracking data 508, which denoises the input perturbed tracking data 406.

Describing the diffusion model 504, it may implement the parameterized neural network F_{θ}. Taking the noise level σ and artificially perturbed ground-truth trajectory x̅ as input, this network may be trained to predict the original noise-free sample by minimizing reconstruction loss. The noise level σ is encoded (e.g., a sinusoidal positional encoding 522) using random Fourier features then concatenated with the perturbed trajectory x̅. By training the model in this way, at inference time the diffusion model 504 can iteratively denoise a random sample of scaled Gaussian noise. To implement this diffusion model 504, the diffusion model 504 may implement a tracking decoder architecture which may include a Transformer-based architecture. It may start by linearly projecting (e.g., by applying a linear layer 520) to each observation in x̅ to a hidden dimension dₕ. Sinusoidal positional encodings 522 are then added to each token based on their temporal index in the sequence. Tokens may then be used as input to K_{d} stacked decoder layers. The stacked decoder layers may apply both temporal attention and then spatial attention to the received tokens. There are two governing objectives of each decoder layer. First, the decoder should encode perturbed trajectories x̅ with conditioning information c in a computationally efficient manner. This may be important given this architecture may be applied to long-term trajectories (i.e., 60 seconds in duration). Secondly, the decoder layers may be permutation equivariant with respect to agent indices. That is, the following equality must hold for every permutation p of agent indices,

$${F}_{θ} ( \overline{x} ; σ , c ) = {F}_{θ} ( {\overline{x}}^{p} ; σ , {c}^{p} ) , ∀ p ∈ [ 1 , {( 10 ! )}^{2} ] , \qquad ( 5 )$$

where x̅^{p} and c^{p} represent permutations of the agent indices for the perturbed ground-truth trajectories and contextual vectors respectively. There may be 102 permutations of player indices because there are two teams typically each with ten outfield players that have no natural ordering.

The diffusion model 504 may obtain computational efficiency by utilizing spatiotemporal axial attention as the module's core operation. Self-attention may have quadratic performance with respect to sequence length, and therefore fully attending across x̅ has O(T² E²). Spatiotemporal axial attention may be used instead, which decomposes self-attention into temporal attention (where attention is performed within each agent trajectory independently), and spatial attention (where attention is applied or performed within each frame independently). Temporal attention has O(ET²) complexity and spatial attention has O(TE²), meaning that collectively Spatiotemporal Axial Attention has O(ET²+TE²)<<O(E²T²). A similar axial approach may be used when cross-attending to conditioning information (e.g., to the output from the multimodal model 502). Each agent may only be permitted to cross-attend with their own conditioning tokens, again to avoid the computational burden of cross attending across T. E tokens. This sub-quadratic performance may considerably augment the diffusion model's 504 capacity to model longer-term trajectories. Furthermore, because spatiotemporal axial attention does not impose an artificial order on agents, this operation may be naturally permutation equivariant.

The diffusion model 504 may also be conditioned on long-term multimodal soccer context (i.e., event data and broadcast tracking). This may allow for the diffusion model 504 to maintain coarse realism, predicting accurate agent locations. To encode this conditioning information, the diffusion model may leverage the multimodal model 502. The output of the multimodal model 502 architecture may be a tensor of shape [T, E, dₕ], which may be a deep latent representation of sequence's event data and broadcast tracking data context. This tensor may form the conditioning information c which the diffusion model 504 cross-attends with. In some examples, the output of the diffusion model may have a linear layer 524 applied to standardize the dimensions of the output prior to outputting the denoised tracking data 508

The trajectory generation module 124 has been applied in experiments to evaluate performance. For reference, the experiments described in this section refer to an Experiment 1. For example, a dataset containing 700 games for training and 52 games for evaluation was used for experiments. These games were taken from high-profile professional leagues. Each game has a paired dataset containing ground-truth tracking x (which was extracted using in-venue tracking systems), broadcast tracking y (which was extracted from publicly accessible broadcast footage), and event data z. Event data was labeled at-scale and reliably by human annotators, though automated event detection could be used as discussed herein.

In the example experiment, two metrics were used in this evaluation, respectively measuring the coarse and fine-grained realism of generated trajectory sets. To evaluate the coarse realism of predicted trajectories, the experiment extracted the average displacement error (“ADE”) in meters between predicted and ground truth trajectories. This value was averaged across each game in the evaluation set. The experiment validated fine-grained realism by focusing on passes. Specifically, in the evaluation dataset, a sub-dataset that contained outfield passes was established. For this sub-dataset, the Pass Failure Rate (“PFR”) was computed, which specifies the frequency of passes where the passer and the ball are not within r=3.5 m at the time of the pass. The PFR was averaged amongst games.

Further, the trajectory generation module 124 was baselined against previous approaches that can encode bidirectional context in multi-agent trajectory sets. The following methods were used as baselines linear interpolator, independent transformer, graph imputer, spatiotemporal transformer, and the multimodal model 502.

The linear interpolator may linearly transition agent locations from their last visible to their next visible location. In situations where agents are not visible over the entire trajectory segment, their locations may be set to the centroid of their teammates' locations.

The independent transformer may reconstruct each agent trajectory independently using a standard Transformer encoder.

The graph imputer may make predictions separately that operate forwards and backwards in time. Each directional prediction may use an RNN to encode each agent's motion, and a GNN to distribute this inter-agent context. The original method's stochasticity may have been ablated.

The spatiotemporal transformer may use a transformer with spatiotemporal axial attention as its core module. Though the model may be used for forecasting, during the experiment its autoregressive mask was removed to enable it to model forwards and backwards in relation to temporal context.

The multimodal model (also referred to as Event2Tracking herein) may implement a multimodal transformer-based model that encodes tracking and event context. This baseline may also use spatiotemporal axial attention as its core operation to process tracking context, and a transformer encoder to encode event data. However, this version of the model may not incorporate the diffusion model to further denoise the trajectories.

The respective models have been trained using sixty second context windows. For each context window, each event in the trajectory bounds was used as input. The ground-truth and broadcast tracking streams were down-sampled to 5 Hz. For the diffusion decoder, the experiment used dₕ=128, with a feedforward neural network dimensionality of 512, and four attention heads. This decoder had K_{d}=8 layers. The noise-level σ may was embedded using 8 random Fourier features. Reflecting the ball's relative importance, the loss incurred by its location was multiplied by a factor of 11. The diffusion model was trained for 36 hours on a cluster of 4 A10 GPUs. The model used a learning rate of 2e-4 using the Adam optimizer (with default exponential decay parameters). The model weights may have been used when its validation loss was minimized.

First, the experiment may have quantitatively compared the proposed method to each baseline in terms of coarse realism. Models' coarse realism may have been established by comparing the ADE between predicted and ground-truth locations. The results for this investigation are reported in Table 1.

TABLE 1

Average Displacement Error (m)

| Method | Player | Ball |
|---|---|---|
| Linear | 6.74 | — |
| Transformer | 4.79 | 16.62 |
| Graph Imputer | 4.61 | 7.97 |
| ST Transformer | 3.63 | 5.44 |
| Event2Tracking | 3.22 | 3.51 |
| Experiment | 3.35 | 3.36 |

Table 1 Evaluates the coarse realism of predicted multi-agent trajectories. In particular, the Average Displacement Error (in meters) is computed between the ground-truth and predicted locations. These values are reported separately for players and the ball. In the example above, “ours” may refer to the trajectory generation module 124.

Of all baselines, the Event2Tracking (e.g., the multimodal model 502) had the strongest performance. It was the only baseline to utilize event data as an input, which considerably improves the model's capacity to reconstruct the ball's location. This is conceptually logical, because event data predominantly provides context as to agents' behaviors with the ball. Consequently, it gives a strong signal as to the ball's location. The Event2Tracking model disclosed herein may be optimized for reconstructing agent locations, highlighting the efficacy of spatiotemporal axial attention for encoding long-term broadcast tracking context.

Compared with the Event2Tracking architecture, an additional implementation of the proposed method has comparable results in terms of ADE. The Event2Tracking architecture outperforms the proposed method implementation in terms of reconstructing player locations, whereas the opposite is true in terms of reconstructing the ball's location, as depicted in Table 1. For both agent classes, the differences between the two models were relatively small. The proposed additional method uses the Event2Tracking model as conditioning information, and therefore it has the access to a latent representation both of event data and broadcast tracking data. However, while the Event2Tracking architecture may be trained to directly optimize only coarse realism via its static L₂ reconstruction loss objective, the proposed additional method may be trained to jointly optimize coarse and fine-grained realism via a denoising diffusion objective. As a result, it may be notable that this broader objective does not come at the cost of its capacity to reconstruct agents' coarse locations.

Next the experiment quantitatively compared the Event2Tracking architecture (e.g., the multimodal model 502) with the proposed additional method implementation (e.g., implementing the trajectory generation module 124) in terms of fine-grained realism. As has been established, the experiment focusses on both models' capacities to reconstruct collectively realistic trajectories around passes. This realism may be quantified using the PFR metric, which computes the percentage of passes where the passer and the ball were within close proximity to each other. Given that the ball is an inanimate object, if this criterion is not fulfilled, the generated pass may not be possible in reality. These results are displayed in Table 2 below.

TABLE 2

| | | Trajectory |
|---|---|---|
| | | generation |
| Method | Event2Tracking | module 124 |
| Pass Failure Rate (%) | 17.67 | 2.19 |

The trajectory generation module 124 method exhibited considerably stronger performance in terms of pass realism that the Event2Tracking model. While 18% of the Event2Tracking model's generated passes may have been unrealistic, the proposed additional method substantially reduces this value to 2%. This may be a substantial improvement, and indicative of the fine-grained realism that can be achieved by a diffusion-based generative approach. Collectively, these results may establish that the trajectory generation module 124 predicted trajectories exhibit strong coarse and fine-grained realism.

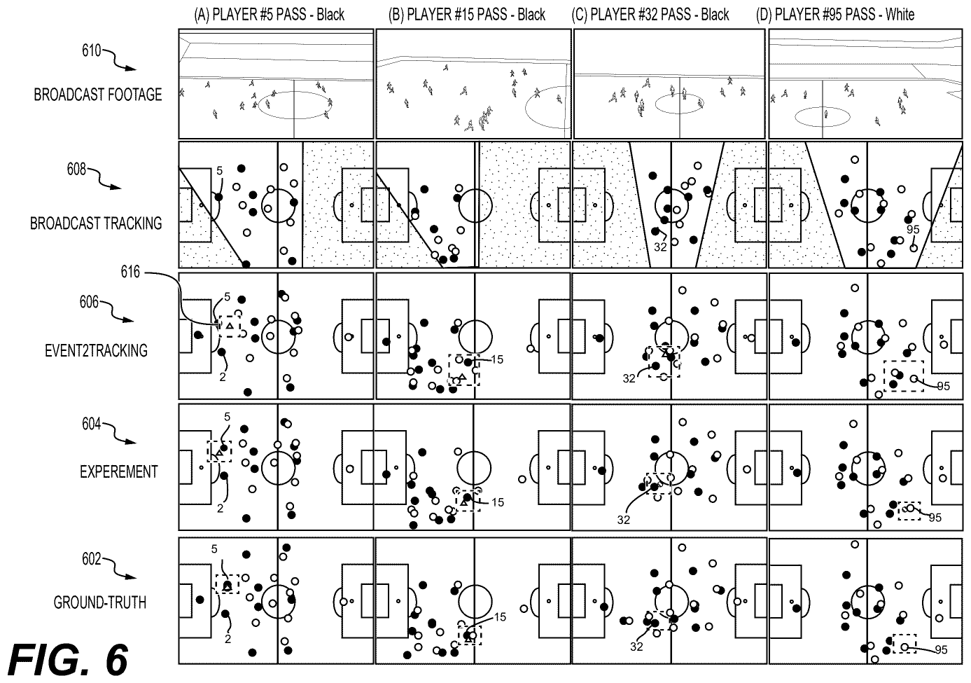

Next the experiment qualitatively evaluated the proposed method's outputs. Four different passes are displayed in FIG. 6, each containing the broadcast footage 610, broadcast tracking 608, Event2Tracking reconstruction 606, an implementation of the proposed additional method's reconstruction 604 (Experiment), and ground-truth tracking 602 at the moment of the pass. FIG. 6 is a set of graphs depicting visualization of broadcast tracking reconstruction settings, according to one or more embodiments. For example, in (a) player #5 (black team) is preparing to pass the ball to a teammate (player #2). In this frame, the Event2Tracking reconstruction 606 predicts the ball (triangle) and player to be in different locations as the ball is already transitioning to player #2. This may not be realistic as the ball is an inanimate object and cannot move if not acted upon by a player. This example therefore may represent a passing failure. In contrast, using the system and method disclosed herein (e.g., the trajectory generation module) as shown via reconstruction 604 appears to be photorealistic, closely matching the ground-truth tracking. Not only are player #5 and the ball in the same coarse locations as they are in ground-truth, but the ball appears to be traveling with player #5 (as in the ground-truth). This reconstruction 604 output may highlight that the model described herein generates motion with fine-grained realism, accurately capturing the concept of ball ownership. Similar results can be observed in for situations (b), (c), and (d).

FIG. 6 visualizes four examples of the broadcast tracking reconstruction setting, where each example is focused on the frame where a pass occurs. Pictured are the broadcast footage 610, broadcast tracking (extracted from broadcast footage) 608, Event2Tracking output of reconstruction 606, output of the proposed additional method reconstruction 604, and the ground-truth tracking 602. In each of the examples for the Event2Tracking output, the ball may be disjointed with the player who is completing the pass (pictured in box 616), which may be indicative of a failure in terms of the PFR metric. In contrast, the proposed method may establish that the player and ball to be in the same general location. This may be indicative of fine-grained realism and is visually similar to the ground-truth trajectories.

Aside from visualizing individual passes, the impact of the method described herein can be understood through the lens of generating a single game of tracking. A broad objective of extracting broadcast tracking may be to do so in a way that is as close as possible to the in-venue data. In a given game, there may be approximately 700 passes. While the Event2Tracking model generates realistic behaviors around 82% of these passes, it may have been demonstrated to fail for the other 18%. In practice, on average this means that it may fail for over 100 passes. In contrast, the additional proposed method described herein may only fail for 2% of passes, corresponding to only 14 in a given game, for example.

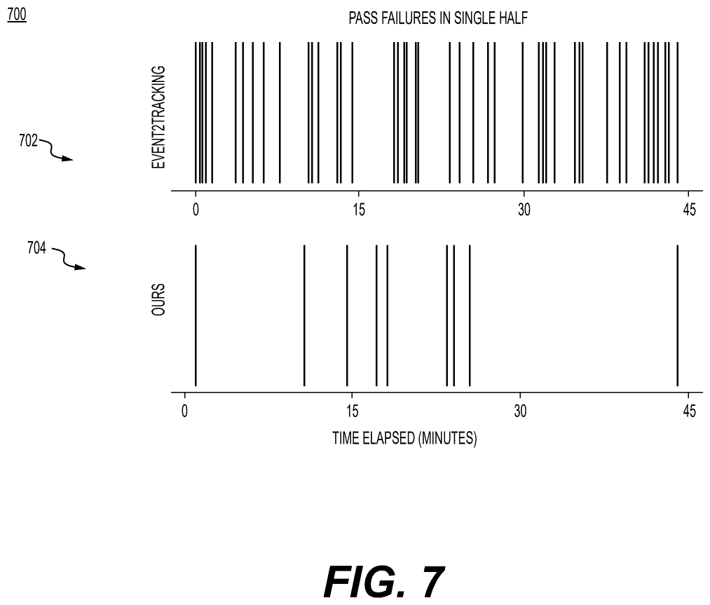

To give a sense of the relative frequencies of these occurrences, a timeline of pass failures in a representative half is provided in FIG. 7. The additional method described herein shown in graph 704 may substantially decrease the frequency of pass failures as compared to the Event2tracking graph 702. In practice, only having 10-20 failures per game allows for each of these failures to be flagged and addressed manually via quality assurance. In contrast, Soley implementing the Event2Tracking model's PFR may simply be too high for each failure to be dealt with manually. This may emphasize the practical impact of generating broadcast tracking with higher fine-grained realism.

FIG. 7 depicts a set of graphs visualizing the frequency of pass failure of a set of models, according to one or more embodiments. FIG. 7 may visualize the frequency of pass failures in a single half (45 minutes) of the Event2Tracking architecture and ours (e.g., the method described herein). In the plots, each vertical bar may correspond to a single pass failure. The Event2Tracking model graph 702 may have 66 pass failures in this half, which corresponds to a PFR of 15%. In contrast, our model graph 704 may decrease this failure rate to 2% (i.e., 9 total failures).

The subject matter disclosed herein describes a diffusion-based method for reconstructing multi-agent soccer trajectories. The described system may illustrate that this generative model substantially improves the fine-grained realism of trajectory sets, especially around passing events. This improvement may be achieved while maintaining state-of-the-art performance in terms of coarse realism (i.e., predicting agents in accurate locations). The advances described herein may be notable because it is the first time that complete broadcast tracking has been able to be extracted in a way where generated trajectories exhibit both coarse and fine-grained collective realism. Outputs of the reconstructed broadcast tracking may be implemented for downstream analysis (e.g., tactical or fitness measures). In addition, approaches described herein may enable the analysis of all games of televised sports (e.g., soccer).

Next, the description surrounding the context and the creation of the multimodal model 502, implemented within the trajectory generation module 124, will be described in greater detail. Certain context related to the multimodal model 502 may first be described, followed by the implementation of the multimodal model 502.

The behaviors of agents (players and the ball) in a sport (e.g., soccer) may form a rich and important testbed for the study of multi-agent adversarial systems The system and methods described herein may model the fine-grained spatiotemporal behaviors of agents in professional soccer games.

The availability of data which encodes agents' fine-grained spatiotemporal behaviors may be a fundamental prerequisite for modelling soccer games. One such data stream may be multi-agent tracking data, which specifies each agent's 2D center of mass at a high framerate (˜25 Hz). Multi-agent tracking data may typically be generated using computer vision systems that may be installed in-venue. However, the prohibitive cost of these systems may limit their broad adoption. A scalable alternative to in-venue systems may be broadcast tracking, where agents are tracked remotely using computer vision from publicly accessible broadcast footage. Unlike in-venue tracking, broadcast tracking may be impeded by partial occlusions (e.g., where some players are not visible due to the camera's narrow receptive field), full occlusions (e.g., where a cut-away causes all players to be unobserved), as well as spatiotemporal noise due to inaccurate detections. The system described herein may, according to certain implementations, focus on using bidirectional temporal context to reconstruct the occlusions and noise in broadcast tracking data.

Reconstructing a sporting event's (e.g., a soccer match's) broadcast tracking may pose many challenges from a modelling perspective. First, players in broadcast footage may frequently exit and enter the moving camera's field-of-view, resulting in heavy occlusions. Although occluded players are outside the camera's receptive field, they may still be active in the game e.g., they adhere to structured individual roles, while still responding to the behaviors of their teammates and opponents. The need to model long-term off-screen behaviors may differentiate soccer from other frequently studied multi-agent tracking scenes. For example, in pedestrian environments, agents that are outside the camera's field-of-view may not typically be modelled and may be assumed to be irrelevant to the scene. Additionally, broadcast cameras in other invasion games such as American football and basketball typically may have much wider fields-of-view relative to the size of the area-of-interest. This may result in much shorter-term occlusions in these games.

Another challenge may be reconstructing the trajectory of the ball. For example, the purpose of soccer is to score goals, which occurs when the ball crosses either team's goal-line. This may make the ball a focal point of soccer. However, while broadcast footage is predominantly centered on the ball its small size, fast-movement, and visual similarity to other entities on the pitch (e.g., pitch markings, players' boots) may make the ball extremely difficult to track optically. For this practical reason, the system may assume that the ball remains fully occluded over the entire duration of games in broadcast tracking.

Previous conventional works that model soccer scenes may be limited in two respects. First, they may only focus on short-term trajectories (typically ≤10 seconds in duration) and therefore may not model the game's longer-term dynamics. Secondly, they may model soccer scenes unimodally (only using trajectory context). This may be especially limiting when reconstructing the motion of the ball, as its location may need to be inferred entirely from the trajectories of players on the pitch. This task may become profoundly difficult in periods of heavy occlusion.

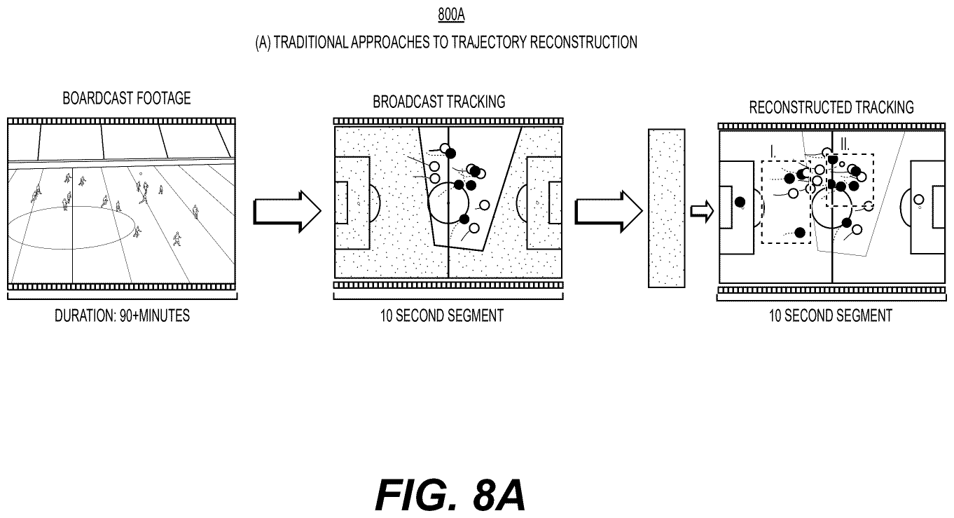

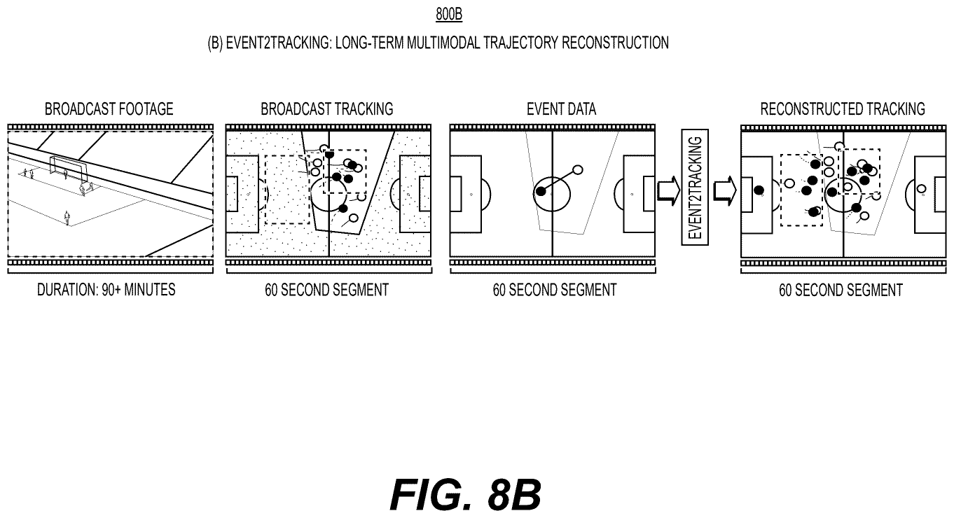

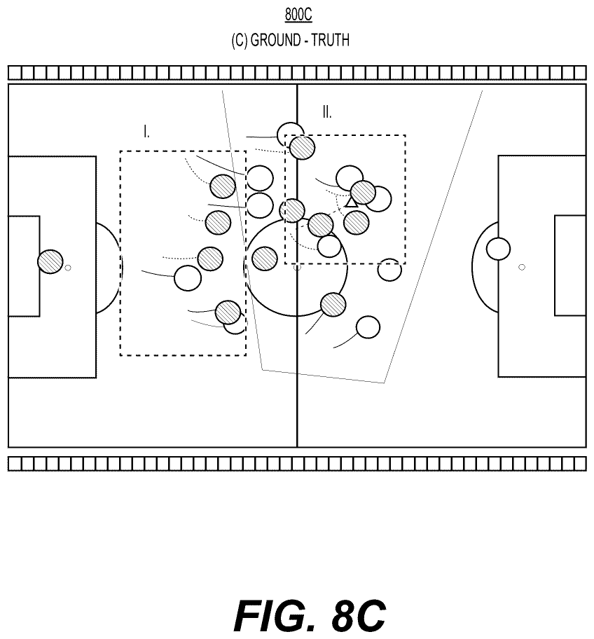

The systems and techniques described herein may tackle these two limitations. The models described herein may be referred to as a tracking model and may be referenced as multimodal model 502 (and displayed as Event2Tracking within the figures described herein). The tracking model architecture may be a long-term multimodal trajectory reconstruction model. The system may identify spatiotemporal axial attention as an effective approach to model longer trajectories than previously studied (e.g., sixty seconds in duration rather than ≤ten seconds). The methods described herein may jointly model long-term trajectories and event data. Event data may be a sparse spatiotemporal data stream which specifies the location, timestamp, and identity of each on and off-ball event in the game. This information stream may be labelled at-scale and reliably by human annotators. As demonstrated in the experiments section herein, the long-term multimodal context may substantially increase the accuracy of the ball and player reconstructed motions. A comparison between the method described herein and traditional trajectory modelling approaches in sport may be shown in FIG. 8A-8C. In summary, the system described herein may demonstrate that spatiotemporal axial attention is an effective approach for modelling longer trajectories than previously studied. The systems and methods described herein may jointly model long-term trajectories with sport (e.g., soccer) event data. The systems and methods described herein may be validated against state-of-the-art baselines on the task of reconstructing soccer broadcast tracking. This may be described in more detail below.

FIG. 8A-8C depicts traditional approaches to trajectories as compared to the models described herein, according to one or more embodiments. FIG. 8A-8C may compare trajectory reconstruction to traditional vs the method described herein. The method described herein may reconstruct multi-agent tracking data extracted from broadcast footage (e.g., tracking data or broadcast tracking). Traditional approaches, depicted in graph 800A, may reconstruct trajectories using short-term (≤10 seconds) unimodal trajectory context. In the tracking models disclosed herein, such as the model depicted in graph 800B, the system may use long-term trajectories (e.g., approximately sixty seconds) as well as sport (e.g., soccer) event data, which may specify the semantic sequence of high-level actions that transpire across the game. As shown when compared against the ground truth of 800C, the method depicted in graph 800B results in reconstructed trajectories more closely matching the ground-truth. This may be most evident in terms of the trajectories of occluded players (as is shown in i. of graph 800C) and the motion of the ball (as is shown in ii. of graph 800C)

Next, the method may describe a process for generating a trajectory prediction by using the multimodal model 502 of FIG. 5. The trajectory reconstruction setting of the system described herein may access two tracking streams: broadcast tracking (which may contain occlusions and noise) and in-venue tracking (which may be complete and accurate). Broadcast tracking for E agents over T timesteps can be represented as a spatiotemporal grid as:

m_{BROADCAST}∈ [symbol] ^{TxExd}^{_{broadcast}}

Each observation in broadcast tracking contains d_{BROADCAST} features, which may include the agent's 2D coordinates, and one-hot encodings of the agent's role, their team affiliation, and their team's current formation. When trajectory observations are occluded, the agent's (x, y) location may be set to a constant value outside the pitch's coordinates. The in-venue stream:

mᵢₙ₋ᵥₑₙᵤₑ∈ [symbol] ^{TxEx2}

may include each agent's (x, y) location at each timestep in the trajectory. Event data may be a 1D temporal stream:

mₑᵥₑₙₜ∈ [symbol] ^{Lxd}^{ₑᵥₑₙₜ}

where L is the number of events in a trajectory window and dₑᵥₑₙₜ may be the dimensionality of each event observation. Each event token may include the 2D coordinate of the event, and one-hot encodings of the event type (e.g., pass, shot, control), and the focused agent's team affiliation, role, and their team's current formation. The training objective is to learn a function F parameterized by θ* where

$${θ}^{*} := {min}_{θ} {ℒ}_{2} ( {f}_{θ} ( {m}_{BROADCAST} , ( {m}_{EVENT} ) ( {m}_{IN - VENUE} )$$

Agents may dynamically enter and exit the broadcast camera's field-of-view. However, despite being off-screen, occluded agents may still be relevant to the scene. The agents may have structured long-term roles, and constantly evolving behaviors based on the actions of their teammates and opposition. As described below, including longer contexts of up to sixty seconds may improve the capacity to reconstruct these impeded trajectories.

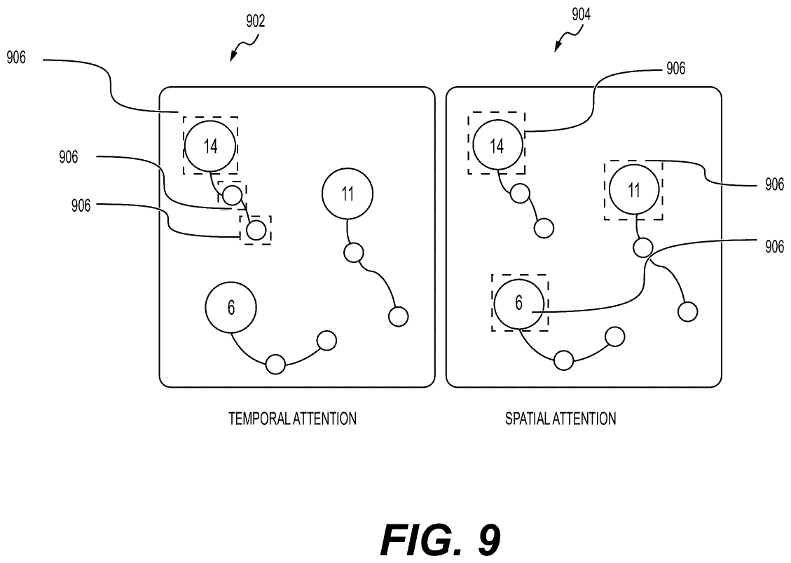

One approach for efficiently modelling multi-agent trajectories with self-attention is spatiotemporal axial attention. Spatiotemporal axial attention may be a module where self-attention is applied across the temporal and spatial axes of multi-agent trajectory sets separately. With this scheme, individual agent motion can be learned through temporal attention, while collective group dynamics can be learned through spatial attention. This is illustrated in FIG. 9, with graph 902 displaying temporal attention and graph 904 displaying spatial attention. A benefit of spatiotemporal axial attention may be its computation efficiency. Self-attention has quadratic performance with respect to sequence length. Therefore, jointly attending across spatial and temporal axes of trajectories has O(T²·E²) complexity. Separate axial attention is of complexity O(T²)+0 (E²)=O(T²) where sequence length T dominates the number of agents E. Despite the efficiency of spatiotemporal axial attention, it may previously have only been applied to short-term trajectories (≤ten seconds in duration). The method described herein notes that the efficiency of spatiotemporal axial attention makes it suitable for modelling considerably longer-term behaviors.

FIG. 9 depicts Illustration of spatiotemporal axial attention. In both attention modules, the squares 906 denote the tokens used for a single attention computation. In temporal attention, self-attention is applied independently within each agent's trajectory, modelling each agent's temporal context. Spatial attention applies self-attention within each individual time step, modelling the inter-agent spatial dependencies that exist in the environment.

Spatiotemporal axial attention may also enable processing of multi-agent trajectories without imposing an artificial ordering on agents. While spatiotemporal data has a clear temporal total ordering (i.e., chronological), no such natural ordering exists over agents spatially. In soccer, because there are two teams with ten outfield players, there are (10!)² possible permutations of agent indices. Consequently, multi-agent trajectory sets may need to be modelled in a way that is permutation equivariant to avoid a combinatorial increase in complexity. Previous approaches may have handled this by imposing an artificial ordering on players based on their locations. The method described herein may implement spatiotemporal axial attention to process multi-agent trajectories in a natively permutation equivariant manner. That is, when modelling trajectories m_{broadcast} with a function which uses spatiotemporal axial attention f, the following equality holds:

$${f ( {m}_{broadcast} )}^{p} = {fm}_{broadcast}^{p} ) , ∀ p ∈ [ 1 , {( 10 ! )}^{2} ] , \qquad ( 1 )$$

where p represents a permutation of the agent indices in the output of spatiotemporal axial attention function ƒ(m_{broadcast}) and the broadcast tracking input m_{broadcast}.

FIG. 10 depicts a block diagram of a multimodal model 502, according to one or more embodiments. In some examples, the multimodal model 502 may be a component of the trajectory generation module 124 described above. The multimodal model 502 may implement spatiotemporal axial attention as a core operation. The method for temporal localization may be described below, followed by a description of the event encoder 512 and tracking decoder 514 architectures.

FIG. 10 illustrates the multimodal model 502, which may jointly model event data and broadcast tracking data to reconstruct multi-agent trajectory sets.

One task common to both the encoding event and tracking data may be temporal localization. That is, specifying the exact timing of each event and tracking observation. The central challenge here may be that both input data sources have non-uniform time intervals (broadcast tracking data is generated at a variable framerate, and events occur sparsely). To address this, for each token, the system may calculate the time elapsed (in milliseconds) from the start of the current trajectory window. The integer value may be used as the index used for sinusoidal positional encoding, allowing for flexible encoding of time in both multimodal inputs.

The multimodal model 502 may include an event encoder 512. The event encoder 512 may receive event data 402 and may encode each event in mₑᵥₑₙₜ. Events may first be tokenized through linear projection (e.g., by linear layer 520), before adding sinusoidal positional encodings 522 to specify each event's temporal occurrence (as detailed above). These tokens may then be processed by a vanilla transformer encoder with N layers, producing event embeddings zₑᵥₑₙₜ∈ [symbol] ^{Lxd}^{ₕ} of latent dimensionality dₕ. The event encoder 512 may not include a temporal attention layer, wherein the event encoder may be a non-temporal encoder that processes input events without modeling temporal dependencies through attention mechanisms. According to implementations disclosed herein, generally longer temporal windows may provide optimal results. However, in certain cases, the temporal attention layer may potentially minimize (e.g., wash out) specific information. Accordingly, in certain implementations, the temporal attention layer may not be used to ensure that the current event is the most important aspect observed by the model. For example, a feedback loop may be implemented to identify a critical event analyzed by the multimodal model 502 (e.g., by assigning a criticality score to the events analyzed by the model). If the criticality score for a current event is below a threshold based on using a given temporal window, a revised output may be generated by reducing the temporal window size and/or be generating the output without triggering the temporal attention layer.

The multimodal model 502 may further include a tracking decoder 514. The tracking decoder 514 may receive broadcast tracking data 404 and may apply spatiotemporal axial attention to the data. The architecture of the multimodal model 502 may enable the joint modelling of event encodings zₑᵥₑₙₜ with broadcast tracking data m_{broadcast}. Each tracking observation may first be tokenized through a linear projection (e.g., by linear layer 520). Following this, sinusoidal positional encodings 522 may be added to specify the temporal ordering of trajectory tokens (as outlined in the section above). Tokens may then be encoded by an attention-based module that is stacked N times. Within this module, tokens may first be processed by spatiotemporal axial attention (temporal attention followed by spatial attention). This may encode the spatiotemporal dependencies of multi-agent trajectories in an efficient, permutation equivariant manner. Next, each agent's trajectory tokens may be cross-attended with the event embeddings zₑᵥₑₙₜ independently, as provided by the event encoder 512 at 1002. This temporal cross-attention operation may fuse broadcast tracking tokens with event context. Next the model may include normalization and feedforward layers which may be standard to transformers. The tracking decoder model returns z_{broadcast}∈ [symbol] ^{Txexd}^{ₕ}, which may represent joint encodings of each agent's event and broadcast tracking streams. Finally, a linear projection 1004 may be used to map each token to an (x, y) prediction 1006, where the prediction 1006 represents reconstructed tracking data.

Next, an experiment performed on the multimodal model 502 is described. For reference, the experiment described in this section is considered Experiment 2. A large dataset was used in the experiments, with seven hundred professional soccer games for training and fifty-two games for evaluation. Each game had a paired dataset of event data mₑᵥₑₙₜ, broadcast tracking m_{broadcast}, and in-venue tracking mᵢₙ₋ᵥₑₙᵤₑ.

The average displacement error (ADE) metric was used for quantitative evaluation. ADE may compute the average Euclidean distance (m) between reconstructed and real locations within a certain trajectory segment. This experiment reported a mean ADE (mADE), which takes the mean ADE calculated over a one-minute trajectory segment both for players and the ball.

The method for modelling soccer scenes with bidirectional temporal context is evaluated. As a result, although multi-agent sporting trajectories may be inherently stochastic, the method described herein is evaluated against deterministic baselines. Baseline evaluations are compared to the linear interpolator, independent transformer, graph imputers, and spatiotemporal transformer (STI) (as shown in Table 3 below).

The linear interpolator may interpolate behaviors between available observations in broadcast tracking. Where players are not visible over the entire trajectory window, their locations are set to the centroid of their team's locations. The independent transformer reconstructs each agent trajectory independently using a transformer. The graph imputer reconstructs trajectories by averaging predictions made forwards and backwards in time. Each directional prediction may use a RNN to model each agent's temporal context, before distributing this context via a GNN. The original method's stochasticity may be ablated. The spatiotemporal transformer may use a transformer with spatiotemporal axial attention. While the conventional method only uses past context, the system described herein may enable bidirectional context by removing the autoregressive attention mask.

Each of the linear interpolator, independent transformer, graph imputers, and spatiotemporal transformer, and the multimodal model 502 were trained separately using ten, twenty, thirty, forty-five, and sixty second context windows to quantify how each approach generalized to longer trajectories. Trajectories of greater length were not considered due to computational constraints. The broadcast and in-venue tracking streams were down sampled to 5 Hz. Each attention module used a hidden dimensionality of 128, and a feedforward dimensionality of 512 and four attention heads. For the Tracking model, the event encoder and tracking decoder each have N=4 layers. During training, the loss incurred in prediction the ball location was weighted by a factor of 11, reflecting the ball's relative importance. All models were trained for sixteen hours on a cluster of four A10 GPUs with a learning rate of 1e-4 using an Adam optimizer (with default exponential decay parameters).

Below may quantitatively compare the multimodal model 502 to each baseline when trained on different segment lengths (10s, 20s, 30, 45s, 60s). The mADE reconstruction loss metrics may be shown for the players and ball in Table 3 (shown below). Notably, the multimodal model 502 architecture outperforms all baselines over every segment length investigated.

TABLE 3

| | mADE Player/Ball (m) | | | | |
|---|---|---|---|---|---|
| | Linear | Independent | Graph | Spatiotemporal | Event2Tracking |
| Context: | Interpolator | Transformer | Imputer | Transformer | (Model 502) |
| 10 s | 8.98/— | 5.80/17.81 | 4.66/7.69 | 4.25/6.23 | 4.13/4.24 |
| 20 s | 7.88/— | 5.30/17.27 | 4.45/7.56 | 3.81/5.71 | 3.44/3.76 |
| 30 s | 7.35/— | 5.22/16.96 | 4.41/7.56 | 3.64/5.33 | 3.33/3.52 |
| 45 s | 6.95/— | 4.77/16.63 | 4.43/7.73 | 3.62/5.48 | 3.27/3.53 |

A first trend shown in Table 3 is that the multimodal model 502 has the strongest performance in terms of reconstructing the ball's motion. Specifically, the method described herein outperforms the next best model (STT) by between 32% and 36% in terms of mADE (ball) across every context length. These architectures may use identical methods to encode the broadcast tracking data (spatiotemporal axial attention). As previously noted, the ball's trajectory is fully occluded in broadcast tracking. As a result, unimodal methods (such as the STT) may need to infer the ball's trajectory only using the motion of visible players. In contrast, techniques implemented using multimodal model 502 may use event data, which contains the time, location, and player identity of every on-ball event in the game. The results indicate that this auxiliary information source is beneficial when predicting the ball's location.

The multimodal model 502 also has the best performance in terms of reconstructing player locations. The method implemented by the multimodal model 502 shows between 3% and 11% lower mADE (players) values across each context window length than the next best model (STT). This may be logical, as event data also provides spatiotemporal context pertaining to the locations of players such that it provides the location of players when they complete an event. While these improvements may be lower in magnitude than the improvements in terms of reconstructing the ball, they further reinforce the utility that event data provides when reconstructing heavily impeded trajectories.

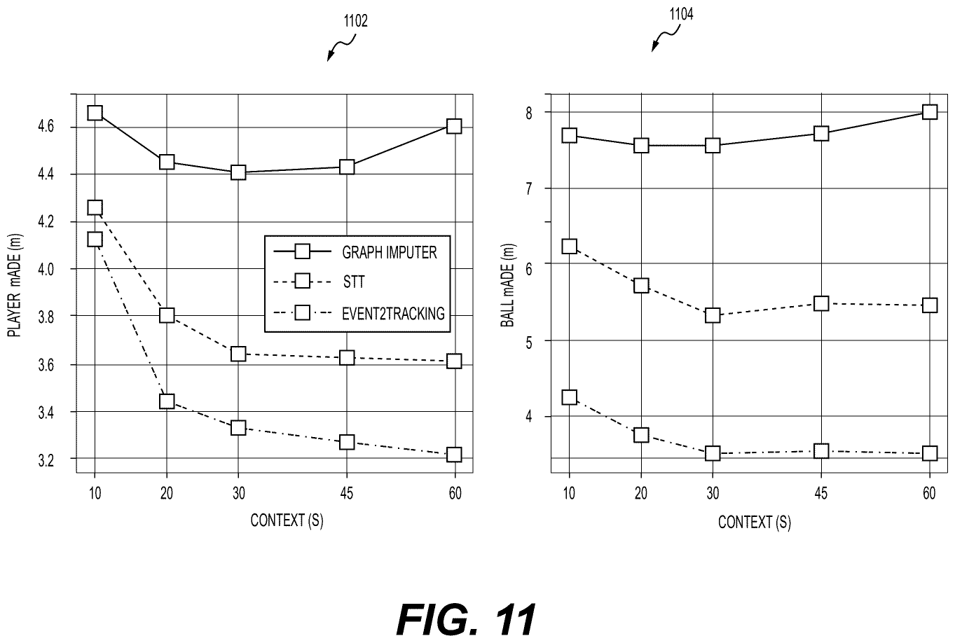

Next, of the deep learning methods, the approach implemented by the multimodal model 502 shows the strongest performance improvements when applied to longer context windows. The multimodal model 502 mADE (players) monotonically improve when applied to longer trajectories (as displayed in FIG. 11). Specifically, its performance for this metric may improve 22% between 10 and 60 second context windows. A similar trend may be observed in the STT's performance (which has the next-best performance), which improves 15% between 10 and 60 second context windows.

FIG. 11 displays performance over longer segments for the baseline and Tracking models. Graph 1102 depicts player mADE vs the various model performances and graph 1104 depicts ball mADE vs the various models' performances. The multimodal model 502 (described as “Event2Tracking in FIG. 11) outperforms each baseline over each context window and tends to improve in performance with more temporal context.

This is a meaningful result, strongly indicating that spatiotemporal axial attention is an effective method for modelling long-term trajectories. Additionally, it highlights the importance of modelling long-term context when reconstructing heavily impeded soccer trajectories. In contrast, the graph imputer's performance only improves 5% from 10s to 30s, before decreasing when applied to longer segments. Its performance is also the weakest of these three models over every segment length. This result may highlight the limitations of the graph imputer for modelling long-term bidirectional context.

To make these results more concrete, the multimodal model 502 performance over a single representative game is inspected. In FIG. 12 the tracking model (multimodal model 502) disclosed herein (60s) is compared against the STT (10s) and (60s) baselines. In terms of mADE (players), the tracking model has strictly lower values than both baselines over the entire game. The tracking model also has the strongest performance over in terms of mADE (ball). While the STT (60s) outperforms the tracking model's method in 7/48 1-minute intervals for this metric, this may be expected variance due to the ball's fast and volatile movement. Additionally, the tracking model's mADE values for both metrics may be much more robust for this game, showing fewer high outlier values. These comparisons further emphasize the efficacy of the Tracking model approach as compared to the baseline systems.

FIG. 12 may display a performance over a full game for when the ball is in-play. FIG. 12 shows mADE values for a players graph 1202 and a ball graph 1204. The tracking model (multimodal model 502) (60s) outperforms both approaches in terms of both metrics for the vast majority of the game.

It is noted that the weakest performance may be exhibited by the linear interpolator and independent transformer. As previously stated, the ball's trajectory is fully occluded in broadcast tracking. As a result, the linear interpolator may be unable to reconstruct its trajectory. This highlights a limitation of interpolation-based approaches. Another limitation of these models may be that they process each agent's trajectory independently. The impact of this may be especially clear in terms of the independent transformer's high ball mADE value. As the ball has no detections, its motion may only be inferred from other agents' motion, or additional streams of information (i.e., event data). As the independent transformer does not model either, it may be unable to accurately reconstruct the ball's trajectory. The inability to model inter-agent dependencies may also result in these models having the two highest mADE (player) metrics for every context window. These results highlight the importance of modelling inter-agent dependencies in reconstructing soccer tracking data.

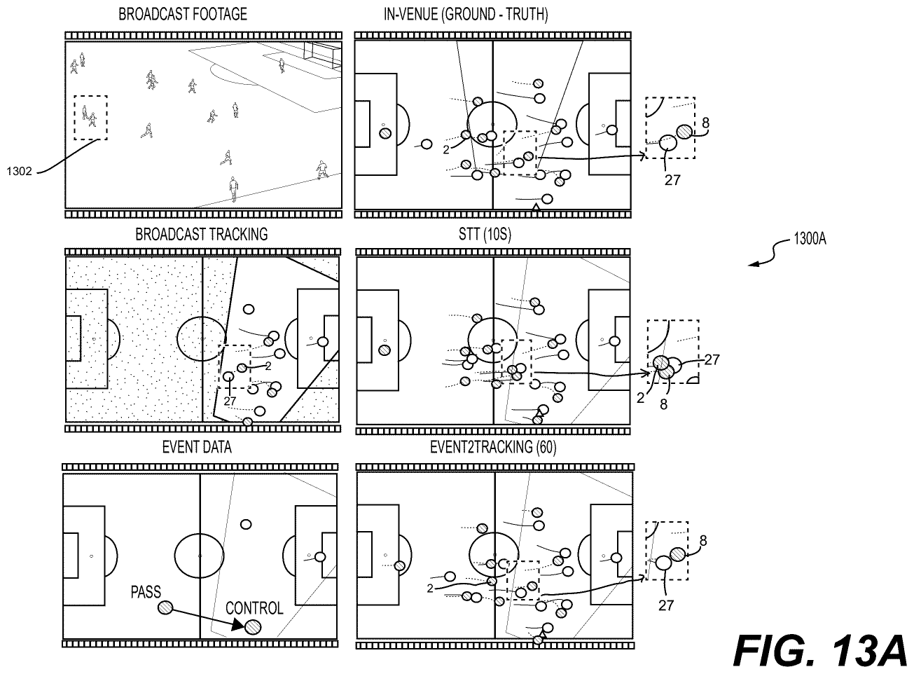

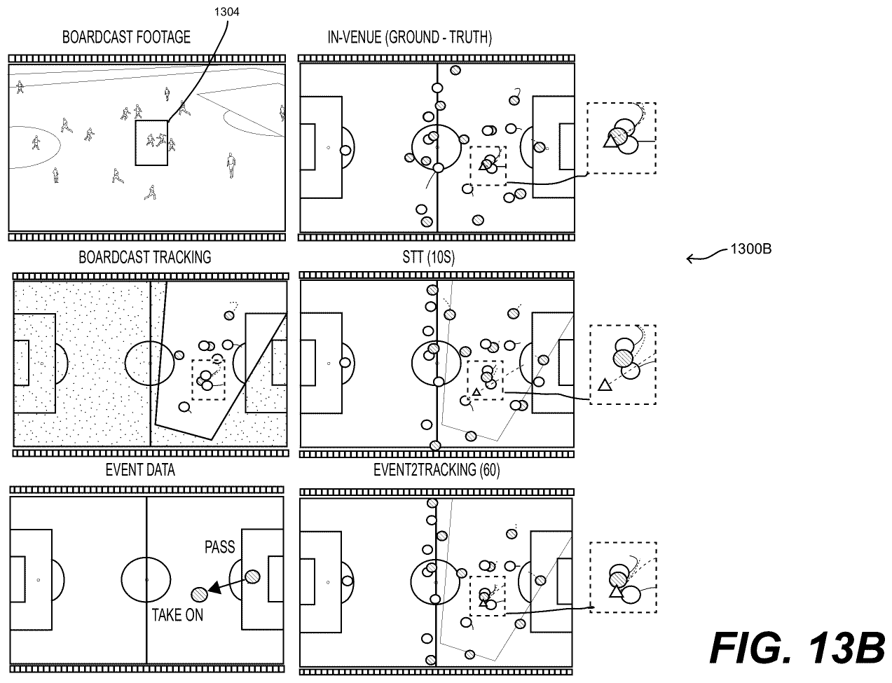

FIG. 13A and FIG. 13B depict qualitative exemplary results, where the broadcast footage, broadcast tracking, event data, in-venue tracking, baseline reconstruction, and multimodal model 502 reconstructions are shown. Diagram 1300A depicts a frame where broadcast tracking misidentifies player #8 for #2 at 1302 (this player is outlined in each plot). Diagram 1300B shows a frame where player completes a take-down event, with the player in focus outlined. The multimodal model 502 method's reconstructions may more closely resemble in-venue compared to baselines.

FIG. 13A depicts an exemplary scenario where an error occurs in broadcast tracking. From the broadcast footage, a player on the first team can be seen on right side of the highlighted portion 1302 of the broadcast footage. The in-venue plot specifies that this player's identity is #8. However, in broadcast tracking this player may be misidentified as player #2. This may be representative of one class of errors that are present in real broadcast tracking systems. Notably, the multimodal model 502 (which may be trained using sixty seconds of context) visibly corrects this error in the exemplary scenario. Specifically, the model predicts player #8 in-view (in their in-venue location) and predicts player #2 to be off-screen (close to their in-venue location). In contrast, the STT model trained using ten seconds of context, which still does not correct this error. Instead, it predicts both players to be in view and in very similar locations, which does not resemble in-venue. As shown, the models disclosed herein depicted as the Event2Tracking model using 60 seconds of context in accordance with the techniques disclosed herein correctly identifies the player as player #8. This example illustrates the benefits of using long term temporal context when reconstructing pervasive tracking errors. When using large context windows, models can attend to more agent behaviors that occur both before and after a tracking error occurs. This provides greater context with which tracking errors can be detected and corrected.

The moment that player #37 performs a take-on event (attempts to dribble past an opponent) is shown in FIG. 13B. In this example, the STT (60s) baseline predicts the ball (triangle) to be multiple meters (scaled) away from the focused player. This is both visibly different to in-venue and represent unrealistic soccer behaviors; a take-on event cannot occur if a player is not in possession of the ball. This highlights the challenges of predicting the ball's location from player motion alone. In contrast, the multimodal model 502 (noted as Event2Tracking) method may use the motion of surrounding players as well as event data, which the time, location, and player involved in the take-on event. Consequently, the multimodal model 502's predicted ball trajectory may closely resemble the in-venue ball trajectory. This example may emphasize the importance of leveraging event context, especially in reconstructing the ball's trajectory.

The method described herein describes a process for reconstructing heavily impeded multi-agent soccer trajectories. As described, using long-term trajectory context as well as soccer's event data stream may considerably increase the fidelity of trajectory reconstructions for players and the ball. The model described herein may enable the stochastic, diverse, and controllable generation of behaviors that may also be consistent with soccer's multimodal long-term structure. The model described herein may be effective as a general-purpose architecture for detecting and predicting other team and player behaviors (e.g., likelihood of a team scoring a goal within a certain time-horizon)

As described in the experiment section of the multimodal model 502, a commercial broadcast tracking dataset was used in Experiment 2 described herein. This dataset was generated from broadcast footage by generating tracking data from the broadcast footage using computer vision (e.g., converting the broadcast footage in a first format to the tracking data dataset in a second format as discussed herein). Broadcast tracking systems may include object detectors, re-identification modules, and camera calibrators.

Compared to in-venue systems, which generate complete and highly accurate tracking data, commercial broadcast tracking data may be both heavily occluded and noisy.

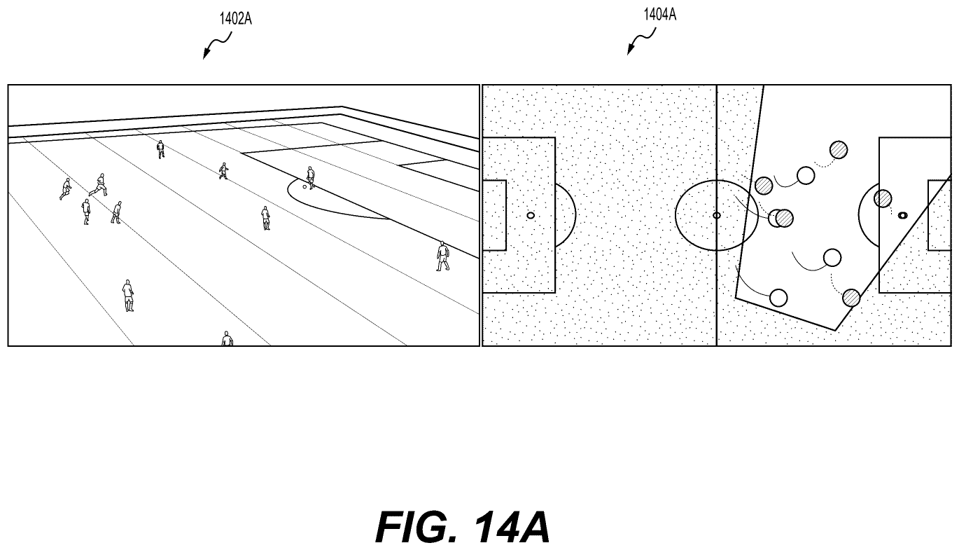

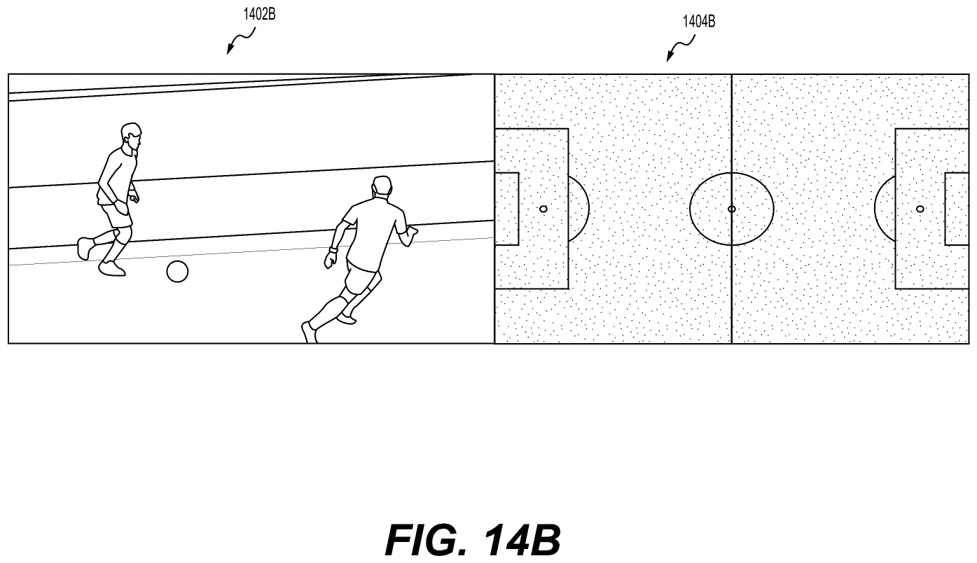

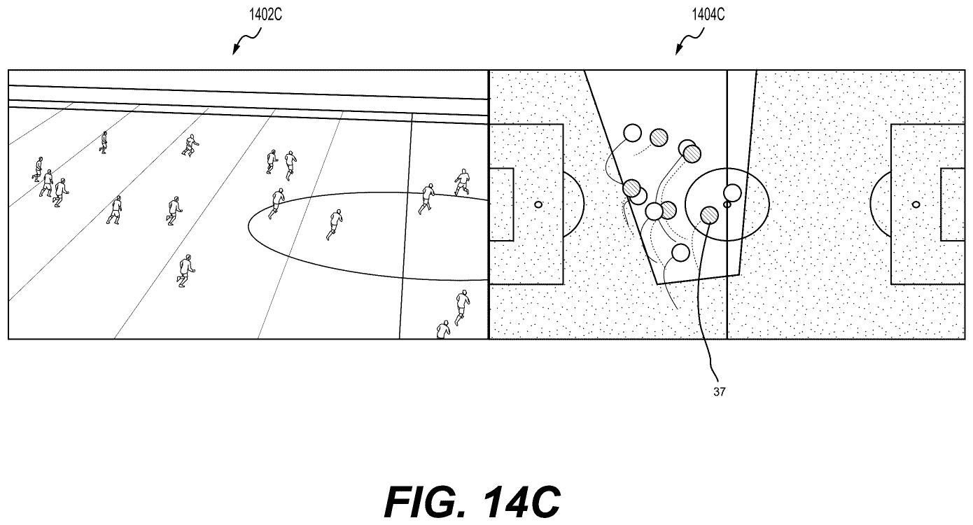

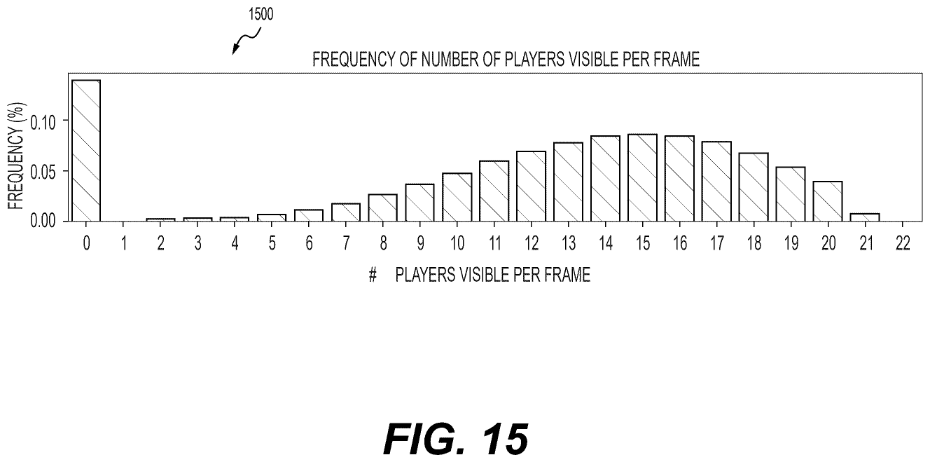

There may be three main classes of occlusions in broadcast tracking. First, broadcast tracking contains partial occlusions due to the camera's limited receptive field. In these portions of the game, agents outside the camera's receptive field are occluded (example shown in FIG. 14A). Secondly, full occlusions may be common in commercial broadcast tracking systems, which occur when no agents can be tracked due to an alternative angle being shown (e.g., close-up, onscreen graphic, advertisement). An example of this is provided in FIG. 14B. Lastly, agents may often occlude each other and cannot be seen by the monocular broadcast camera. This most commonly impacts the ball, as is shown in FIG. 14C. The number of detections per frame in the evaluation dataset is depicted in graph 1500 of FIG. 15. Graph 1500 displays the frequency of each number of detections per frame in the evaluation set.

FIG. 14A displays a partial inclusion example, FIG. 14B displays a full occlusion example, and FIG. 14C displays an inter-agent occlusion example. These depict the three different forms of occlusions discussed herein. Broadcast footage 1402A, 1402B, and 1402C and broadcast tracking 1404A, 1404B, and 1404C are shown on the left and right respectively. In FIG. 14A, an example of a partial occlusion is given as depicted via broadcast footage shown in 1402A and generated tracking data shown in 1404A, where only 9/22 players are visible in broadcast footage shown in 1402A. A situation of full occlusion is shown in FIG. 14B, where a close-up results in no broadcast tracking being available. Specifically, the close-up broadcast footage shown in 1402B results in no context or resulting tracking data shown in 1404B. An inter-agent occlusion is displayed in FIG. 14C, where the ball cannot be perceived as it is behind a player #37.

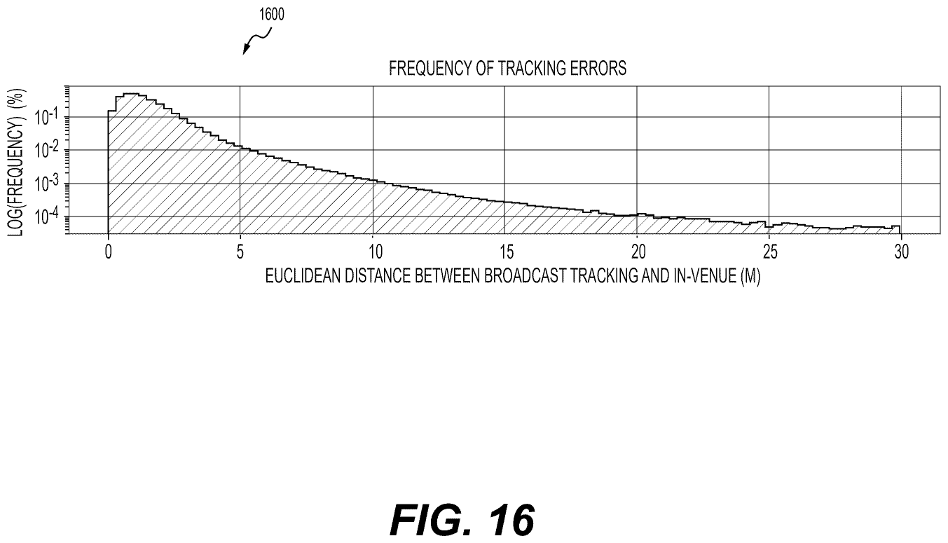

Tracking errors can occur at each stage of the broadcast tracking pipeline, causing various types of noise in agent trajectories. In terms of object detection, the ball may be frequently mis-detected due to its similar visual appearance to other objects on the field (e.g., pitch markings, player boots, objects in crowd). Agents may also be frequently misidentified. Players may dress homogeneously within teams, which may make vision-based re-identification challenging. Most commonly, there may be errors stemming from inaccurate camera calibration. Even small miscalibrations can result in dramatic errors, as a result of the pitch's large size. The statistics of the tracking errors across the evaluation dataset are shown in FIG. 16 in graph 1600. Graph 1600 displays the frequency of different levels of tracking errors, measured in terms of the Euclidean distance between broadcast tracking and in-venue tracking (m).

Conventional systems that model multi-agent sporting trajectories may use broadcast tracking as a research setting. However, these systems may synthesize broadcast tracking from in-venue data. While this may allow for a constrained research setting, this synthetic data may be unrealistic for various reasons. Primarily, previous approaches may only have synthesized the occlusions that stem from the camera's limited field-of-view. As a result, they may not model full occlusions, agent inter-occlusions, or any forms of tracking errors that are universal in real broadcast tracking systems. Additionally, conventional systems may assume that all agents are visible at the starts and ends of trajectory segments, which may not be realistic to broadcast footage.

Broadcast tracking videos may also be studied from a computer vision perspective, in a conventional system, which provides benchmarks on an end-to-end broadcast tracking task. The broadcast footage utilized herein may be taken from an impeded broadcast camera that continually perceives the area-of-interest. This may not resemble a realistic broadcast tracking setting, where there are frequent cut-aways and alternative angles being shown.

The limitations of conventional formulations led to the use of outputs of a commercial broadcast tracking system. This may both form a more realistic and challenging setting for modelling multi-agent sporting trajectories.

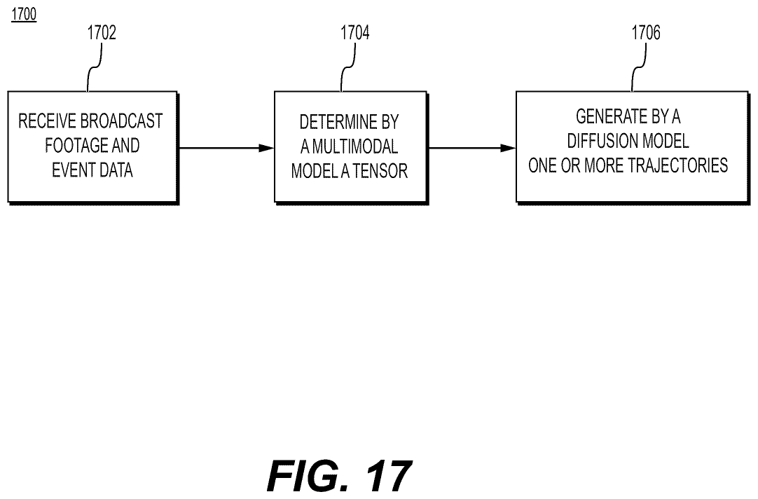

FIG. 17 depicts a flowchart 1700 of an exemplary method of generating a trajectory according to one or more embodiments. The flowchart 17 may depict an exemplary method that may be applied by aspects of the trajectory generation module 124 described above.

Step 1702 may include receiving broadcast footage and event data. This may include receiving, as an input, broadcast footage of a sporting event. This may further include determining tracking data tracking data of one or more players in the sporting event from the broadcast footage, the tracking data including one or more vectors. The tracking data and one or more vectors may be the broadcast tracking data 404 described in FIG. 4. The one or more vectors may include at least one of an agent two dimensional coordinates on a sporting event's field, an agent position, an agent team, an indicator indicating the agent is a ball, or player visibility information. Step 1702 may include receiving event data of the sporting events. In some examples, the event data may be derived from the broadcast footage (e.g., implementing the techniques discussed in FIG. 1). The event data may be the event data 402 described in FIG. 4. The event data may include event data includes a sequential stream of one or more major events throughout a sport event, the major events including at least one of a pass, shot, tackle, foul, turnover, penalty, goal, score, or substitution from the sporting event.

The method may further include inputting the one or more vectors and event data into a multimodal model (e.g., multimodal model 502). This may include applying a linear layer of the multimodal model to the one or more vectors and event data to tokenize the event data and one or more vectors. The method may include inputting the event data into an event encoder (e.g., event encoder 512). The method may include inputting the one or more vectors into a tracking decoder (e.g., the tracking decoder 514).

Step 1704 may include determining, by the multimodal model, a tensor, the tensor representing a representation of sequences of the event data and tracking data. This step may include adding a first set of sinusoidal positioning embeddings to the event data; and processing the event data by applying a transformer encoder in the event encoder to produce event embeddings. The event embeddings may then be output to the tracking decoder.

The method may further include adding a second set of sinusoidal positioning embeddings to the a tokenized versions of the one or more vectors; encoding the tokenized version of the one or more vectors by an attention based module in the tracking decoder; applying cross attention of the event embeddings to the encoded tokenized versions of the one or more vectors; applying a normalization layer to the encoded tokenized versions of the one or more vectors; and applying a feedforward layer to the encoded tokenized versions of the one or more vectors. The diffusion model may then output a tensor to the diffusion model (e.g., diffusion model 504).

The method may further include receiving, by the diffusion model (e.g., diffusion model 504) an input of perturbed tracking data (e.g., perturbed tracking data 406).

Step 1706 may include generating, by the diffusion model, one or more trajectories for the one or more players in the sporting event. This may include applying a linear layer to the perturbed tracking data; applying sinusoidal positional encoding to the perturbed tracking data; applying, by the diffusion model, spatiotemporal axial attention to the perturbed tracking data; and applying cross-attention to the perturbed tracking data with the tensor. The one or more trajectories include a predicted sequence of movements for the one or more players for a next approximately sixty seconds of the sporting event.

Accordingly, among other improvements, the systems and methods disclosed herein improve tracking data generation for events by more accurately converting a content feed (e.g., a broadcast video feed) to tracking data using a multimodal model, tensors, transformers, and/or diffusion models. Such improvements enable accurate depictions of the given event and further allow for accurate downstream applications such as analysis conducted based on the tracking data (e.g., automated detection of events, prediction of events, triggering downstream actions, and/or the like). For example, the more accurate (e.g., realistic) tracking data generated in accordance with the techniques disclosed herein may be used to automatically identify the occurrence of an event (e.g., a sporting action such as a pass, score, formation, play, etc.) and such identification of an event may trigger an automated downstream action in a manner that was not previously possible with a threshold accuracy. Such downstream actions may include triggering an automated generation of an odds market, an automated update to an odds market, automated generation of one more graphics or streams depicting an event or a result of an event, automated player and/or team updates, automated generation of highlight reels based on timings, players, and/or objects identified as associated with an identified event, or the like. The method may further include generating future trajectories of the one or more players by analyzing the one or more trajectories generated in accordance with the techniques disclosed herein.

According to implementations of the subject matter disclosed herein, the improved tracking data may be used to determine the motion of all players and/or event information. Using the improved tracking data, body-pose reconstruction may be performed. For example, location, speed, acceleration, and corresponding events (for individuals and/or objects) may be extracted from the improved tracking data discussed herein. These attributes may be input into a body-pose model to the possible body-pose(s) an individual may have during the corresponding events. For example, the model may be trained based on historical or simulated location, speed, acceleration, corresponding events and corresponding historical or simulated body pose information. Subsequently, the location, speed, acceleration, and corresponding events for a sporting event may be extracted from the improved tracking data and may be matched to body-pose information (e.g., having likelihood scores).

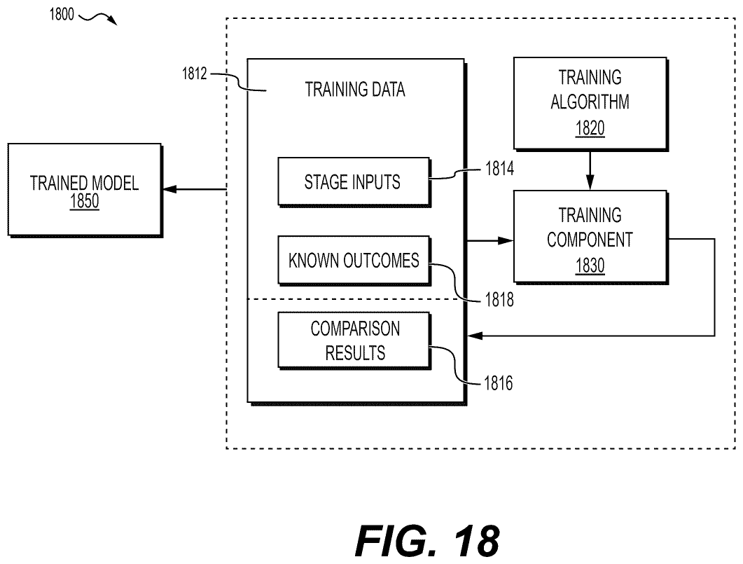

FIG. 18 depicts a flow diagram for training a machine learning model, in accordance with an aspect of the disclosed subject matter. As shown in flow diagram 1800 of FIG. 18, training data 1812 may include one or more of stage inputs 1814 and known outcomes 1818 related to a machine learning model to be trained. The stage inputs 1814 may be from any applicable source including a component or set shown in the figures provided herein. The known outcomes 1818 may be included for machine learning models generated based on supervised or semi-supervised training. An unsupervised machine learning model might not be trained using known outcomes 1818. Known outcomes 1818 may include known or desired outputs for future inputs similar to or in the same category as stage inputs 1814 that do not have corresponding known outputs.

The training data 1812 and a training algorithm 1820 may be provided to a training component 1830 that may apply the training data 1812 to the training algorithm 1820 to generate a trained machine learning model 1850. According to an implementation, the training component 1830 may be provided comparison results 1816 that compare a previous output of the corresponding machine learning model to apply the previous result to re-train the machine learning model. The comparison results 1816 may be used by the training component 1830 to update the corresponding machine learning model. The training algorithm 1820 may utilize machine learning networks and/or models including but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 1800 may be a trained machine learning model 1850.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

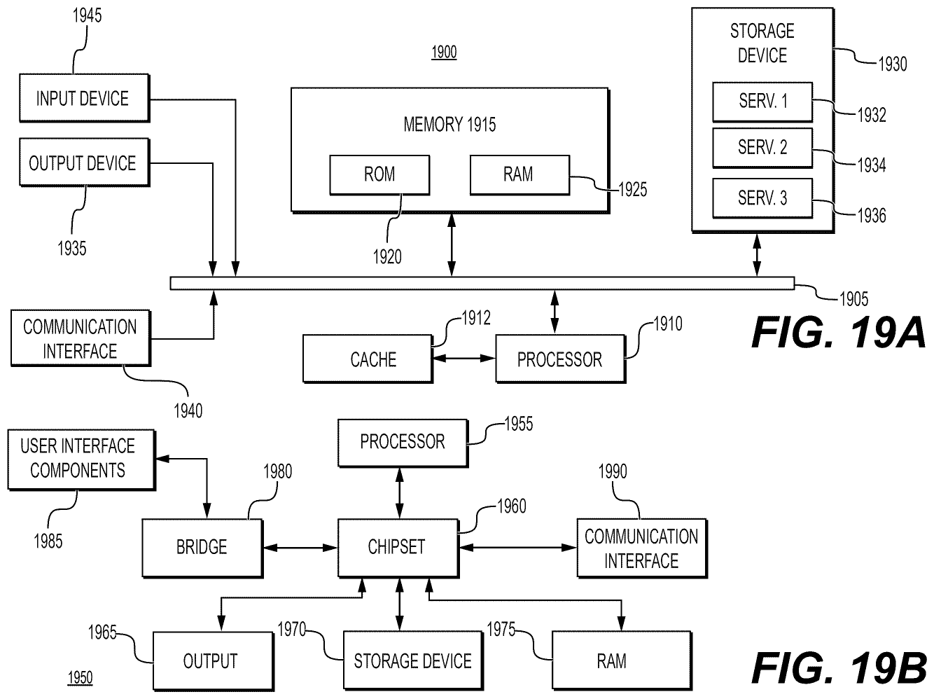

FIG. 19A illustrates an architecture of computing system 1900, according to example embodiments. System 1900 may be representative of at least a portion of organization computing system 104. One or more components of system 1900 may be in electrical communication with each other using a bus 1905. System 1900 may include a processing unit (CPU or processor) 1910 and a system bus 1905 that couples various system components including the system memory 1915, such as read only memory (ROM) 1920 and random access memory (RAM) 1925, to processor 1910. System 1900 may include a cache of high-speed memory connected directly with, in close proximity to, or integrated as part of processor 1910. System 1900 may copy data from memory 1915 and/or storage device 1930 to cache 1912 for quick access by processor 1910. In this way, cache 1912 may provide a performance boost that avoids processor 1910 delays while waiting for data. These and other modules may control or be configured to control processor 1910 to perform various actions. Other system memory 1915 may be available for use as well. Memory 1915 may include multiple different types of memory with different performance characteristics. Processor 1910 may include any general purpose processor and a hardware module or software module, such as service 1 1932, service 2 1934, and service 3 1936 stored in storage device 1930, configured to control processor 1910 as well as a special-purpose processor where software instructions are incorporated into the actual processor design. Processor 1910 may essentially be a completely self-contained computing system, containing multiple cores or processors, a bus, memory controller, cache, etc. A multi-core processor may be symmetric or asymmetric.

To enable user interaction with the computing system 1900, an input device 1945 may represent any number of input mechanisms, such as a microphone for speech, a touch-sensitive screen for gesture or graphical input, keyboard, mouse, motion input, speech and so forth. An output device 1935 (e.g., display) may also be one or more of a number of output mechanisms known to those of skill in the art. In some instances, multimodal systems may enable a user to provide multiple types of input to communicate with computing system 1900. Communications interface 1940 may generally govern and manage the user input and system output. There is no restriction on operating on any particular hardware arrangement and therefore the basic features here may easily be substituted for improved hardware or firmware arrangements as they are developed.

Storage device 1930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1925, read only memory (ROM) 1920, and hybrids thereof.

Storage device 1930 may include services 1932, 1934, and 1936 for controlling the processor 1910. Other hardware or software modules are contemplated. Storage device 1930 may be connected to system bus 1905. In one aspect, a hardware module that performs a particular function may include the software component stored in a computer-readable medium in connection with the necessary hardware components, such as processor 1910, bus 1905, output device 1935, and so forth, to carry out the function.

FIG. 19B illustrates a computer system 1950 having a chipset architecture that may represent at least a portion of organization computing system 104. Computer system 1950 may be an example of computer hardware, software, and firmware that may be used to implement the disclosed technology. System 1950 may include a processor 1955, representative of any number of physically and/or logically distinct resources capable of executing software, firmware, and hardware configured to perform identified computations. Processor 1955 may communicate with a chipset 1960 that may control input to and output from processor 1955. In this example, chipset 1960 outputs information to output 1965, such as a display, and may read and write information to storage device 1970, which may include magnetic media, and solid-state media, for example. Chipset 1960 may also read data from and write data to RAM 1975. A bridge 1980 for interfacing with a variety of user interface components 1985 may be provided for interfacing with chipset 1960. Such user interface components 1985 may include a keyboard, a microphone, touch detection and processing circuitry, a pointing device, such as a mouse, and so on. In general, inputs to system 1950 may come from any of a variety of sources, machine generated and/or human generated.

Chipset 1960 may also interface with one or more communication interfaces 1990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1955 analyzing data stored in storage device 1970 or RAM 1975. Further, the machine may receive inputs from a user through user interface components 1985 and execute appropriate functions, such as browsing functions by interpreting these inputs using processor 1955.

It may be appreciated that example systems 1900 and 1950 may have more than one processor 1910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for generating trajectories for one or more players during a sporting event, the method comprising:
receiving, as an input, broadcast footage of a sporting event;
determining tracking data of one or more players in the sporting event from the broadcast footage, the tracking data including one or more vectors;
receiving event data of the sporting event;
inputting the one or more vectors and event data into a multimodal model, the multimodal model including:
an event encoder; and
an tracking decoder;
applying a linear layer of the multimodal model to the one or more vectors and event data to tokenize the event data and one or more vectors;
determining, by the multimodal model, a tensor, the tensor representing a representation of sequence of the event data and tracking data;
receiving perturbed tracking data of the sporting event;
inputting the perturbed tracking data and tensor into a diffusion model, wherein the diffusion model includes a decoder; and
generating, by the diffusion model, one or more trajectories for the one or more players in the sporting event.

2. The method of claim 1, wherein one or more vectors includes at least one of an agent's two dimensional coordinates on a sporting event's field, an agent position, an agent team, an indicator indicating the agent is a ball, or player visibility information.

3. The method of claim 1, wherein the event data was derived from the broadcast footage.

4. The method of claim 1, wherein the event data includes a sequential stream of one or more major events throughout a sport event, the major events including at least one of a pass, shot, tackle, foul, turnover, penalty, goal, score, or substitution from the sporting event.

5. The method of claim 1, wherein the event encoder does not include a temporal attention layer wherein the event encoder is a non-temporal encoder that processes input events without modeling temporal dependencies through attention mechanisms.

6. The method of claim 1, wherein determining, by the multimodal model, a tensor further comprises:
adding a first set of sinusoidal positioning embeddings to the event data; and
processing the event data by applying a transformer encoder in the event encoder to produce event embeddings.

7. The method of claim 6, wherein determining, by the multimodal model, a tensor further comprises:
adding a second set of sinusoidal positioning embeddings to tokenized versions of the one or more vectors;
encoding the tokenized version of the one or more vectors by an attention based module in the tracking decoder;
applying cross attention of the event embeddings to the encoded tokenized versions of the one or more vectors;
applying a normalization layer to the encoded tokenized versions of the one or more vectors; and
applying a feedforward layer to the encoded tokenized versions of the one or more vectors.

8. The method of claim 1, wherein the generating, by the diffusion model, one or more trajectories for the one or more players in the sporting event further comprises:
applying a linear layer to the perturbed tracking data;
applying sinusoidal positional encoding to the perturbed tracking data;
applying, by the diffusion model, spatiotemporal axial attention to the perturbed tracking data; and
applying cross-attention to the perturbed tracking data with the tensor.

9. The method of claim 1, wherein the one or more trajectories include a predicted sequence of movements for the one or more players for a next approximately sixty seconds of the sporting event.

10. The method of claim 1, further comprising:
generating future trajectories of the one or more players by analyzing the one or more trajectories.

11. A system for generating trajectories for one or more players during a sporting event, the system comprising:
a memory configured to store processor-readable instructions; and
a processor operatively connected to the memory, and configured to execute the instructions to perform operations comprising:
receiving, as an input, broadcast footage of a sporting event;
determining tracking data of one or more players in the sporting event from the broadcast footage, the tracking data including one or more vectors;
receiving event data of the sporting event;
inputting the one or more vectors and event data into a multimodal model, the multimodal model including:
an event encoder; and
an tracking decoder;
applying a linear layer of the multimodal model to the one or more vectors and event data to tokenize the event data and one or more vectors;
determining, by the multimodal model, a tensor, the tensor representing a representation of sequence of the event data and tracking data;
receiving perturbed tracking data of the sporting event;
inputting the perturbed tracking data and tensor into a diffusion model, wherein the diffusion model includes a decoder; and
generating, by the diffusion model, one or more trajectories for the one or more players in the sporting event.

12. The system of claim 11, wherein one or more vectors includes at least one of an agent's two dimensional coordinates on a sporting event's field, an agent position, an agent team, an indicator indicating the agent is a ball, or player visibility information.

13. The system of claim 11, wherein the event data was derived from the broadcast footage.

14. The system of claim 11, wherein the event data includes a sequential stream of one or more major events throughout a sport event, the major events including at least one of a pass, shot, tackle, foul, turnover, penalty, goal, score, or substitution from the sporting event.

15. The system of claim 11, wherein the event encoder does not include a temporal attention layer wherein the event encoder is a non-temporal encoder that processes input events without modeling temporal dependencies through attention mechanisms.

16. The system of claim 11, wherein determining, by the multimodal model, a tensor further comprises:
adding a first set of sinusoidal positioning embeddings to the event data; and
processing the event data by applying a transformer encoder in the event encoder to produce event embeddings.

17. The system of claim 16, wherein determining, by the multimodal model, a tensor further comprises:
adding a second set of sinusoidal positioning embeddings to tokenized versions of the one or more vectors;
encoding the tokenized version of the one or more vectors by an attention based module in the tracking decoder;
applying cross attention of the event embeddings to the encoded tokenized versions of the one or more vectors;
applying a normalization layer to the encoded tokenized versions of the one or more vectors; and
applying a feedforward layer to the encoded tokenized versions of the one or more vectors.

18. A non-transitory computer readable medium configured to store processor-readable instructions, wherein when executed by a processor, the instructions perform operations comprising:
receiving, as an input, broadcast footage of a sporting event;
determining tracking data of one or more players in the sporting event from the broadcast footage, the tracking data including one or more vectors;
receiving event data of the sporting event;
inputting the one or more vectors and event data into a multimodal model, the multimodal model including:
an event encoder; and
an tracking decoder;
applying a linear layer of the multimodal model to the one or more vectors and event data to tokenize the event data and one or more vectors;
determining, by the multimodal model, a tensor, the tensor representing a representation of sequence of the event data and tracking data;
receiving perturbed tracking data of the sporting event;
inputting the perturbed tracking data and tensor into a diffusion model, wherein the diffusion model includes a decoder; and
generating, by the diffusion model, one or more trajectories for the one or more players in the sporting event.

19. The non-transitory computer readable medium of claim 18, wherein one or more vectors includes at least one of an agent two dimensional coordinates on a sporting event's field, an agent position, an agent team, an indicator indicating the agent is a ball, or player visibility information.

20. The non-transitory computer readable medium of claim 18, wherein the event data was derived from the broadcast footage.
